(19) United States
(12) Patent Application Publication
(10) Pub. No.: US 2026/0191221 A1
(43) Pub. Date: Jul. 9, 2026

(54) Micro-Puree Machine Having a Force Limiting Mechanism

(71) Applicant: SharkNinja Operating LLC, Needham, MA (US)

(72) Inventors: Nathan Lyell, Suffolk (GB); Jonathan James, Witney (GB); Lauren Holliday, Bexley (GB)

(21) Appl. No.: 19/012,557

(22) Filed: Jan. 7, 2025

(51) Int. Cl. A23G 9/22

(52) U.S. Cl. CPC A23G 9/222

(57) ABSTRACT

A bowl for use with a micro-puree machine including a first end, a second end, and a sidewall extending between the first and second ends, the sidewall defining an interior volume of the bowl, the second end of the bowl including an outlet in fluid communication with an interior of the bowl, and a dial configured to be operatively connected to the second end of the bowl. The dial includes a seal and at least one tab extending from an inner surface of the dial. At least one slot is defined on an exterior surface of the bowl at the second end thereof, the at least one slot corresponding to the at least one tab.

### FIELD

The present disclosure relates to a food processing device and, more particularly, to a micro-puree machine with an integrated nozzle for dispensing ingredients from the food processing bowl.

### BACKGROUND

Domestic kitchen appliances that are intended to make ice creams, gelatos, frozen yogurts, sorbets and the like are known in the art. Typically, a user adds a series of non-frozen ingredients to a mixing bowl, which often has been previously cooled, for example, in a freezer. The ingredients are then churned by a one or more paddles (sometimes referred to as dashers) while a refrigeration mechanism simultaneously freezes the ingredients. These devices have known shortcomings including, but not limited to, the amount of time and effort required by the user to complete the ice cream-making process. Machines of this nature are also impractical for preparing most non-dessert food products.

An alternative type of machine known for making a frozen food product may be referred to as a micro-puree machine. Typically, machines of this nature spin and plunge a blade into a pre-frozen ingredient or combination of ingredients. While able to make frozen desserts like ice creams, gelatos, frozen yogurts, sorbets and the like, micro-puree machines can also prepare non-dessert types of foods such as non-dessert purees and mousses.

### SUMMARY

In some embodiments, the disclosure describes an extrusion assembly for a micro puree machine. The extrusion assembly uses a plunger to extrude ingredients from a bowl. Movement of the plunger may be controlled using a lever that is manually rotated by a user. Torque exerted on the lever (with or without the assistance of a motor) is transferred to the extrusion drive train to move the plunger through the bowl. However, if the contents within the bowl are too hard (e.g., unprocessed ingredients, under-processed ingredients, if foreign objects are present, etc.), damage can occur when extruding or attempting to extrude the contents of the bowl. Possible types of damage that can occur if too much force is exerted on certain components of the extrusion assembly include drive train damage (e.g., damage to gears, leadscrew, motor, etc.), damage to the bowl, and/or damage to the main housing of the micro puree machine.

To protect the drive train and other componentry of the extrusion assembly, a force limiting mechanism provided with the bowl may be used to selectively restrict or eliminate force input torque (e.g., manual force applied to the extrusion lever or input force applied by a motor) from being applied to the extrusion drive train. The force limiting mechanism can be configured to restrict input torque from reaching the extrusion drive train if the amount of force encountered by the plunger is above a predetermined safe limit. The force limiting mechanism of the bowl may utilize various different mechanical and/or electrical features to restrict input force from transferring to the extrusion drive train. Some of these force-limiting mechanisms are described below.

In some embodiments, a bowl for use with a micro-puree machine may include a first end, a second end, and a sidewall extending between the first and second ends, the sidewall defining an interior volume of the bowl, the second end of the bowl including an outlet in fluid communication with an interior of the bowl, and a dial configured to be operatively connected to the second end of the bowl. The dial may include a seal and at least one tab extending from an inner surface of the dial. At least one slot may be defined on an exterior surface of the bowl at the second end thereof, the at least one slot corresponding to the at least one tab.

In some embodiments, upon a sufficient pressure being applied to the seal of the dial, the at least tab may be configured to release from the at least one slot. The sufficient pressure may be at least 150 kilogram-force. The at least one slot may include a first end, a second end, and a middle portion extending between the first and second ends, in which the first and second ends extend circumferentially about the second end of the bowl. Upon a sufficient pressure being applied to the seal of the dial, the at least tab may be configured to release from the at least one slot, in which the sufficient pressure is predetermined. The at least one tab may include at least two tabs circumferentially positioned around the inner surface of the dial. A number of tabs provided on the inner surface of the dial may correspond to a number of slots defined on the outer surface of the second end of the bowl. The at least one tab may include at least two tabs that correspond to the same slot. The at least one tab may be oblong-shaped. Upon a sufficient pressure being applied to the seal of the dial, the at least tab may be configured to release from the at least one slot to allow the dial to release from the second end of the bowl.

In some embodiments, a bowl for use with a micro-puree machine may include a first end, a second end, and a sidewall extending between the first and second ends, the sidewall defining an interior volume of the bowl, the second end of the bowl including an outlet in fluid communication with an interior of the bowl, and a dial configured to be operatively connected to the second end of the bowl. The dial may include a seal, a base member received by a cavity defined by the seal, and a retaining member held in the seal and operatively engaged with the base member. Upon sufficient pressure being applied against the seal, the base member and retaining member may be configured to release from one another.

In some embodiments, upon release of the base member and retaining member from one another, the seal may be configured to move relative to the dial to release the pressure exerted against the seal. The seal may be operatively engaged with the base member. The seal may include a post member that is received in an aperture defined by the base member. The base member may include at least one tab configured to operatively engage with at least one tab extending from the retaining member. Upon sufficient pressure being exerted against the seal, the at least one tab of the base member may be pushed past the at least one tab of the retaining member to allow the seal to move relative to the dial to release the pressure being exerted on the seal. The base member may define at least one aperture to receive the at least one tab of the retaining member. The retaining member may include at least one tab extending from an outer surface thereof and that is received in an aperture defined in an inner surface of the seal.

In some embodiments, a method of releasing pressure in a bowl for a micro-puree machine ma include operatively connecting a dial to the bowl of the micro-puree machine, and releasing the dial from the bowl of the micro-puree machine upon a predetermined force being applied to the dial. The dial may be configured to fully release from the bowl upon the predetermined force being applied to the dial.

The present invention is further disclosed in the following clauses:

Clause 1: A bowl for use with a micro-puree machine, the bowl comprising: a first end, a second end, and a sidewall extending between the first and second ends, the sidewall defining an interior volume of the bowl, the second end of the bowl including an outlet in fluid communication with an interior of the bowl; and a dial configured to be operatively connected to the second end of the bowl, the dial comprising: a seal; and at least one tab extending from an inner surface of the dial, wherein at least one slot is defined on an exterior surface of the bowl at the second end thereof, the at least one slot corresponding to the at least one tab.

Clause 2: The bowl of Clause 1, wherein, upon a sufficient pressure being applied to the seal of the dial, the at least tab is configured to release from the at least one slot.

Clause 3: The bowl of Clause 1 or Clause 2, wherein the sufficient pressure is at least 150 kilogram-force.

Clause 4: The bowl of any of Clauses 1-3, wherein the at least one slot comprises a first end, a second end, and a middle portion extending between the first and second ends, in which the first and second ends extend circumferentially about the second end of the bowl.

Clause 5: The bowl of any of Clauses 1-4, wherein, upon a sufficient pressure being applied to the seal of the dial, the at least tab is configured to release from the at least one slot, in which the sufficient pressure is predetermined.

Clause 6: The bowl of any of Clauses 1-5, wherein the at least one tab comprises at least two tabs circumferentially positioned around the inner surface of the dial.

Clause 7: The bowl of any of Clauses 1-6, wherein a number of tabs provided on the inner surface of the dial corresponds to a number of slots defined on the outer surface of the second end of the bowl.

Clause 8: The bowl of any of Clauses 1-7, wherein the at least one tab comprises at least two tabs that correspond to the same slot.

Clause 9: The bowl of any of Clauses 1-8, wherein the at least one tab is oblong-shaped.

Clause 10: The bowl of any of Clauses 1-9, wherein, upon a sufficient pressure being applied to the seal of the dial, the at least tab is configured to release from the at least one slot to allow the dial to release from the second end of the bowl.

Clause 11: A bowl for use with a micro-puree machine, the bowl comprising: a first end, a second end, and a sidewall extending between the first and second ends, the sidewall defining an interior volume of the bowl, the second end of the bowl including an outlet in fluid communication with an interior of the bowl; and a dial configured to be operatively connected to the second end of the bowl, the dial comprising: a seal; a base member received by a cavity defined by the seal; and a retaining member held in the seal and operatively engaged with the base member, wherein, upon sufficient pressure being applied against the seal, the base member and retaining member are configured to release from one another.

Clause 12: The bowl of Clause 11, wherein, upon release of the base member and retaining member from one another, the seal is configured to move relative to the dial to release the pressure exerted against the seal.

Clause 13: The bowl of Clause 11 or Clause 12, wherein the seal is operatively engaged with the base member.

Clause 14: The bowl of Clause 13, wherein the seal comprises a post member that is received in an aperture defined by the base member.

Clause 15: The bowl of any of Clauses 11-14, wherein the base member comprises at least one tab configured to operatively engage with at least one tab extending from the retaining member.

Clause 16: The bowl of Clause 15, wherein, upon sufficient pressure being exerted against the seal, the at least one tab of the base member is pushed past the at least one tab of the retaining member to allow the seal to move relative to the dial to release the pressure being exerted on the seal.

Clause 17: The bowl of Clause 15 or Clause 16, wherein the base member defines at least one aperture to receive the at least one tab of the retaining member.

Clause 18: The bowl of any of Clauses 11-17, wherein the retaining member comprises at least one tab extending from an outer surface thereof and that is received in an aperture defined in an inner surface of the seal.

Clause 19: A method of releasing pressure in a bowl for a micro-puree machine, the method comprising: operatively connecting a dial to the bowl of the micro-puree machine; and releasing the dial from the bowl of the micro-puree machine upon a predetermined force being applied to the dial.

Clause 20: The method of Clause 19, wherein the dial is configured to fully release from the bowl upon the predetermined force being applied to the dial.

A reading of the following detailed description and a review of the associated drawings will make apparent the advantages of these and other structures. Both the foregoing general description and the following detailed description serve as an explanation only and do not restrict aspects of the disclosure as claimed.

### BRIEF DESCRIPTION OF THE DRAWINGS

Reference to the detailed description, combined with the following figures, will make the disclosure more fully understood, wherein:

FIG. 1A shows an isometric view of a micro-puree machine, according to some embodiments of the disclosure;

FIG. 1B shows the micro-puree machine of FIG. 1A with the bowl assembly disassembled from the housing, according to some embodiments of the disclosure;

FIGS. 1C-1G illustrate embodiments of extrusion assemblies, bowl assemblies, and/or nozzle assemblies of the micro-puree machine of FIG. 1A, according to some embodiments of the disclosure;

FIG. 2A illustrates a portion of another micro-puree machine, according to some embodiments of the disclosure;

FIG. 2B illustrates a reversible bowl assembly that may be coupled to the micro-puree machine of FIG. 2A, according to some embodiments of the disclosure;

FIG. 3A shows another reversible bowl assembly, according to some embodiments of the disclosure;

FIG. 3B shows a blade of the reversible bowl assembly of FIG. 3A, according to some embodiments of the disclosure;

FIG. 3C is a cut-away view of the reversible bowl assembly and first lid of FIGS. 3A and 3B, according to some embodiments of the disclosure;

FIG. 3D shows a detailed view of an embodiment of a plunger coupled to the underside of a second lid, according to some embodiments of the disclosure;

FIGS. 4A and 4B illustrate the use of the reversible bowl assembly of FIGS. 3A-3D, according to some embodiments of the disclosure;

FIGS. 5A-5F illustrate another micro-puree machine, according to some embodiments of the disclosure;

FIG. 6A illustrates a nozzle control assembly of a micro-puree machine, according to some embodiments of the disclosure;

FIGS. 6B-6I illustrate the use of the nozzle control assembly of FIG. 6A, according to some embodiments of the disclosure;

FIGS. 7A-7F illustrate another nozzle control assembly of a micro-puree machine in an open position, according to some embodiments of the disclosure;

FIGS. 7G-7J illustrate the nozzle control assembly of FIGS. 7A-7F in a closed position, according to some embodiments of the disclosure;

FIGS. 8-11 illustrate a force limiting mechanism for a bowl for a micro-puree machine according to some embodiments of the disclosure; and

FIGS. 12 and 13 illustrate another force limiting mechanism for a bowl for a micro-puree machine according to some embodiments of the disclosure.

### DETAILED DESCRIPTION

In the following description, like components have the same reference numerals, regardless of different illustrated embodiments. To illustrate embodiments clearly and concisely, the drawings may not necessarily reflect appropriate scale and may have certain structures shown in somewhat schematic form. The disclosure may describe and/or illustrate structures in one embodiment, and in the same way or in a similar way in one or more other embodiments, and/or combined with or instead of the structures of the other embodiments.

In the specification and claims, for the purposes of describing and defining the invention, the terms “about” and “substantially” represent the inherent degree of uncertainty attributed to any quantitative comparison, value, measurement, or other representation. The terms “about” and “substantially” moreover represent the degree by which a quantitative representation may vary from a stated reference without resulting in a change in the basic function of the subject matter at issue. Open-ended terms, such as “comprise,” “include,” and/or plural forms of each, include the listed parts and can include additional parts not listed, while terms such as “and/or” include one or more of the listed parts and combinations of the listed parts. Use of the terms “top,” “bottom,” “above,” “below” and the like helps only in the clear description of the disclosure and does not limit the structure, positioning and/or operation of the disclosure in any manner.

Notably, the mechanisms and techniques described herein may be used to configure a machine to process (e.g., micro-puree and perhaps aerate) and extrude ice cream and other frozen ingredients. That is, both the processing and extrusion functions can be performed by a single machine. In such a machine, a same shaft may be used to drive a blade to process the frozen ingredients in a bowl (i.e., a container) and to drive a plunger to extrude the processed ingredients from the bowl. Further, such a machine may include a user interface enabling a user to control the timing of the performance of each function. In some implementations of such a machine, a first shaft may be used to drive processing and a second shaft may be used to drive extrusion, and such implementations may be considered to have a first sub-system or module for processing and a second sub-system or module for extrusion.

In some embodiments, a single lid may be provided (e.g., on an open end of the bowl) that houses (or is coupled to) a blade for processing ingredients, and that also houses (or is coupled to) a plunger for extruding the processed ingredients. In such embodiments, a single shaft driven by one or more motors (e.g., one motor for driving rotation of blade; the other motor for driving linear movement of the driven shaft along its axis) may drive both the processing that uses the blade and the extrusion that uses the plunger, as described in more detail elsewhere herein, and an end of the bowl opposite the lid may include an opening for extrusion of the processed ingredients from the bowl.

In other embodiments, to enable the performance of both functions, the user may flip the processing bowl from a first arrangement, in which the driven shaft engages a blade at a first end of the processing bowl (e.g., the blade housed in or coupled to a first lid at a first open end of the processing bowl), to a second arrangement, in which the driven shaft engages a plunger at a second end of the processing bowl (e.g., the plunger housed in or coupled to a second lid at an open second end of the processing bowl), as described in more detail herein. In such embodiments, the first lid also may include an opening for extruding the ingredients from the bowl during extrusion using the plunger in the second arrangement. Further, in such embodiments, a single shaft driven by one or more motors may drive both the processing by use of the blade and the extrusion by use of the plunger, as described in more detail elsewhere herein.

In other embodiments, to enable the performance of both functions, the user may replace a first lid (e.g., housing or coupled to a blade) for processing from an open end of the processing bowl with a second lid (e.g., housing or coupled to a plunger) for extruding, as described in more detail elsewhere herein. In such embodiments, a single shaft driven by one or more motors may drive both the processing by use of the blade and the extrusion by use of the plunger, or alternatively, a separate shaft may be used for extruding, in which such separate shaft drives the plunger, as described in more detail elsewhere herein.

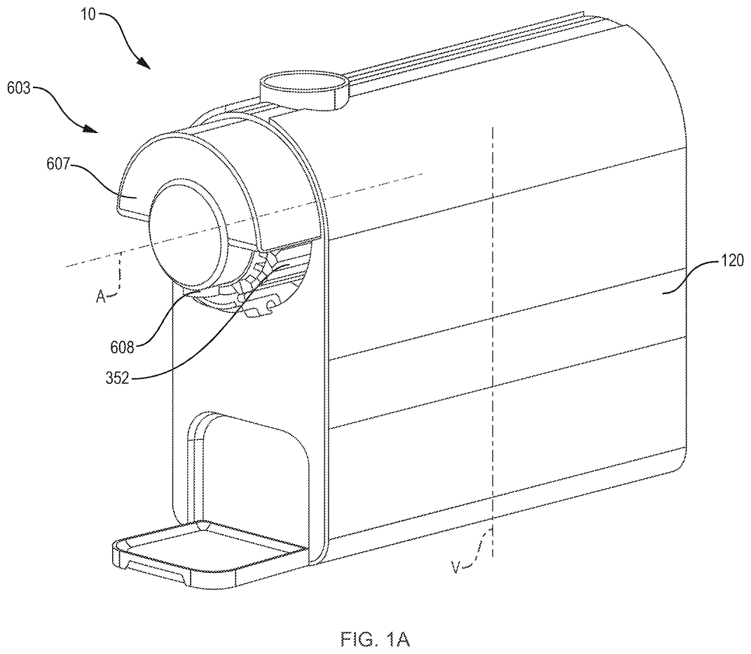

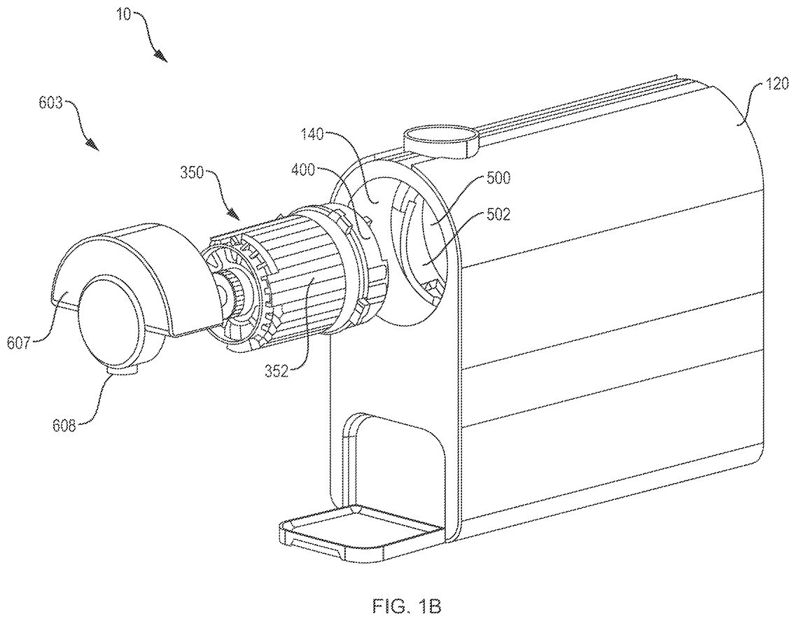

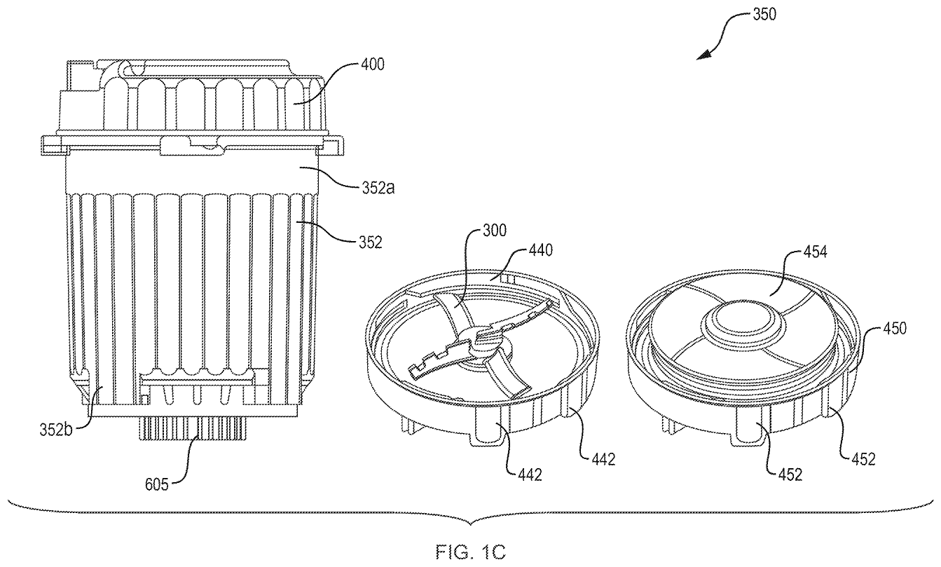

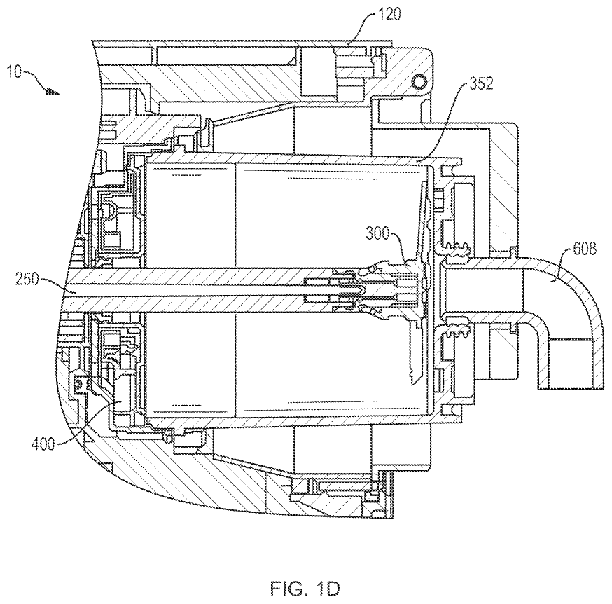

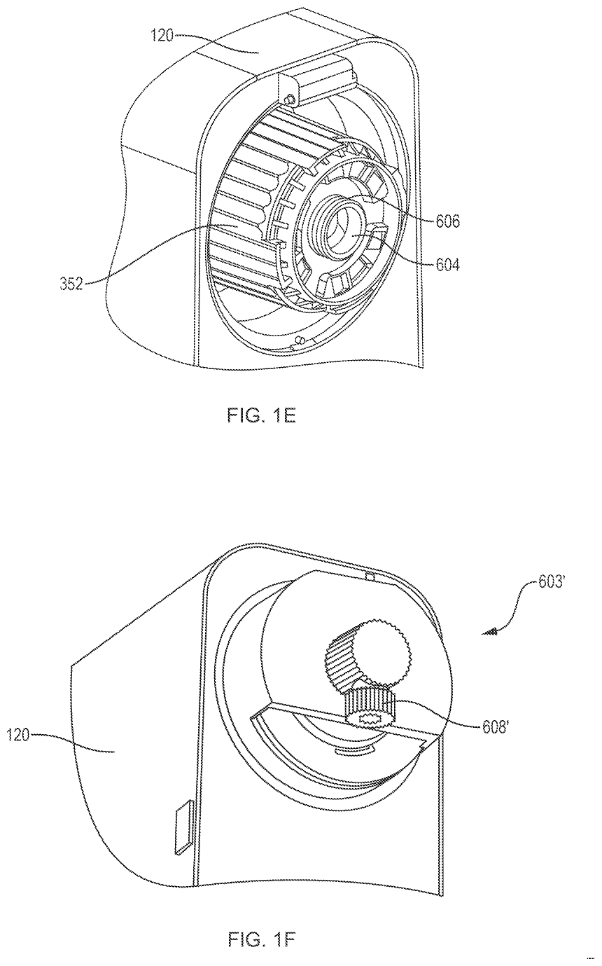

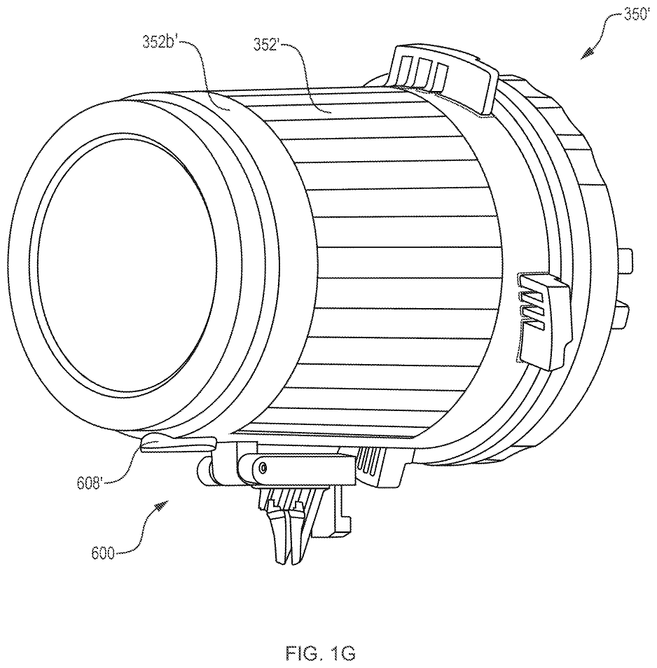

FIG. 1A shows an isometric view of a micro-puree machine 10 according to some embodiments of the disclosure. FIG. 1B shows the micro-puree machine 10 of FIG. 1A with the bowl assembly 350 disassembled from the housing 120 according to some embodiments of the disclosure. FIGS. 1C-1G illustrate embodiments of the extrusion assemblies, bowl assemblies, and/or nozzle assemblies, according to some embodiments of the disclosure.

The micro-puree machine 10 may include a housing 120, which may include a user interface (not shown) for receiving user inputs to control the micro-puree machine 10 and/or display information. The micro-puree machine 10 also may include a bowl assembly 350 and a nozzle assembly 603. The combination of a bowl assembly 350, which may include a lid 400 configured for extruding, and a nozzle assembly 605 may be referred to herein as an extrusion assembly. The nozzle assembly 603 may include a nozzle housing 607 and a nozzle 608.

The bowl assembly 350 may include a bowl 352 configured to contain one or more processed ingredients, ingredients to be processed, or ingredients being processed. A user may couple the bowl assembly 350 to the housing 120 by rotating the bowl assembly 350 relative to the housing 120 (e.g., using screwing threads or a bayonet connection), or by another coupling mechanism and/or technique. The bowl assembly 350 may be assembled to the housing 120 such that a central axis A of the bowl assembly 350 extends perpendicular to a vertical axis V of the housing 120, as shown. However, the disclosure contemplates that the bowl assembly 350 may be assembled to the housing 120 such that the central axis A extends at an angle between 0 and 90° to the vertical axis, for example, as described in U.S. Pat. No. 11,759,057 to SharkNinja Operating LLC, the entire contents of which are hereby incorporated by reference (the '057 patent), or such that the central axis of the bowl assembly 350 extends parallel to the vertical axis V, for example, as described in U.S. Pat. No. 11,871,765 to SharkNinja Operating LLC, the entire contents of which are hereby incorporated by reference (the '756 patent). In embodiments, the bowl 352 of the bowl assembly 350 can be manufactured from a disposable material to enhance the convenience of using the micro-puree machine 10. Further, the bowl 352 can be sold as a stand-alone item and can also be prefilled with ingredients to be processed during use of the micro-puree machine 10.

As shown in FIG. 1B, the housing 120 may include a coupling 500 disposed within an opening 140 of the housing 120. An inner surface 502 of the coupling 500 may comprise locating and locking elements for positioning and connecting the bowl assembly 350 to the coupling 500 in two different configurations, as described elsewhere herein. The micro-puree machine 10 may further include a nozzle 608 couplable to the bowl assembly 350 for extruding processed ingredients from the bowl assembly 350. The nozzle 608 may be arranged such that the ingredients are extruded in a vertically downward direction such that a user can place an ice cream cone, cup, bowl, or other edible or non-edible receptacle underneath the nozzle to receive extruded ingredients. The disclosure also contemplates that multiple nozzle shapes may be provided to allow for user customizability. For example, multiple nozzles may be included on a rotatable dial that allows the user to select the desired nozzle shape. In further embodiments, the extrude function may be integrated into a program on the user interface with a predetermined translation speed/flow rate.

As shown in FIG. 1C, the first end 352a of the bowl 352 may be configured to couple to both a first lid 440 and the second lid 450. The first lid 440 may include a blade 300 for processing ingredients, for example, a blade as described in the '765 patent. When the lid 440 is coupled to the bowl 352 (e.g., via reciprocal threading on the bowl and lid), the bowl assembly 350 may be considered to be in a processing configuration and may be coupled to the housing via coupling 500. The lid 440 may have locating and locking elements 442 on its exterior sidewall configured to couple to the locating and locking elements on the inner surface 502 of the coupling 500. The second lid 450 may include a plunger 454 for extruding ingredients. The plunger 454 may furthermore include a flexible seal around its perimeter to ensure contact (e.g., maximum contact) with the sidewall of the bowl 352 to allow for optimal (e.g., maximum) extrusion yield. When the lid 450 is coupled to the bowl 352 (e.g., via reciprocal threading on the bowl and lid), the bowl assembly 350 may be considered to be in an extruding configuration and may be coupled to the housing via coupling 500. The lid 450 may have locating and locking elements 452 on its exterior sidewall configured to couple to the locating and locking elements on the inner surface 502 of the coupling 500.

The second end 352b of the bowl 352 may include a centrally located opening 604, or an opening that is not centrally located, including a coupling collar 606. The coupling collar 606 may include threading or other types of coupling features, for example, slots or cams, e.g., for bayoneting. The opening 604 may be enclosed by a cap 605, for example, during processing, which cap may be removed during extruding. The cap 605 may include interior threading (not shown) or other coupling features that allow it to couple to the coupling collar 606. The opening 604 may further be in fluid communication with a nozzle 608. For example, the opening 604 may be in fluid communication with a nozzle through a conduit (e.g., plastic tubing) that extends from the opening 604 to the nozzle 608, e.g., within nozzle assembly 603. In embodiments, such a conduit may include one or more sections connected by joints (e.g., an elbow joint) to translate the direction (e.g., horizontal) of extrusion from opening 604 to a direction (e.g., vertically downward) of extrusion from the nozzle 608.

As shown in FIG. 1D, the user may attach the first lid 440 to the bowl 352 and couple the bowl assembly 350 to the micro-puree machine 10 using the coupling features described herein. The lid 440 may be configured (e.g., as described in the '765 patent) such that, when the lid 440 is coupling to the housing 120, the blade 300 engages a driven shaft 250 and disengages the lid 440. Through use of a user interface (e.g., as described in the '057 patent), the user may activate a program that controls the blade 300 to rotate and move (e.g., descend or move horizontally or at an angle) into the ingredients in the bowl 352 to process (e.g., micro-puree) them. It should be appreciated that in some embodiments, as shown in FIG. 1D, the nozzle assembly 603 or one or more components thereof (e.g., nozzle 608) may be coupled to the second end 352b of the bowl 350 (and perhaps to the housing) even when extrusion is not being performed, e.g., during processing. In such embodiments, the opening 604 may be closed, for example, using cap 605 or by other means. FIG. 1E is a bottom view of the bowl assembly 350 while coupled to the housing, in which the opening 604 is not covered. In actual use, the opening 604 may be closed, e.g., by cap 605, during processing, or open and coupled to the nozzle assembly 603 during extrusion.

After processing the ingredients in the bowl 352, the user then may remove the bowl assembly 350 from the micro-puree machine 10, remove the first lid 440 from first end 352a, replace it with lid 450 on the first end 352a, couple the nozzle assembly to the second end 352b of the bowl assembly 350 if not already attached, couple the bowl assembly 350 to the housing 120, and initiate extrusion via the user interface. During extrusion, the driven shaft drives the plunger 602 from the first end 352a of the bowl 352 to the second end 352b of the bowl, forcing the processed ingredients to extrude the processed ingredients through the opening 604 and through the nozzle 608.

FIG. 1F illustrates another embodiment of a nozzle assembly 603′, including nozzle 608′, which may be used to extrude processed ingredients, for example, using mechanisms and techniques described herein.

FIG. 1G illustrates another bowl assembly 350′including the extrusion assembly 600 according to some embodiments of the disclosure. As shown in FIG. 1G, the bowl assembly 350′ may include a nozzle 608′ that is integrated with the bottom edge of the bowl 352′, for example, on the sidewall of the bowl 352′ proximate to a second end 352b′ or extending past the second end 352b′. In embodiments, the bowl assembly 350′ may be configured to be installed to the coupling 500 such that the nozzle 608′ faces vertically downwards when the bowl 352′ is properly installed. During extrusion, the movement of the plunger (e.g., plunger 454) will force the processed ingredients through the nozzle 608′. The nozzle 608′ may be selectively located on the bowl 352′ to optimize the amount of processed ingredients that can be extruded, thus minimizing the amount of yield loss after extrusion. For example, the nozzle 608′ may be located near the bottom edge of the bowl 352′, as shown in FIG. 1G. However, the disclosure contemplates that the nozzle 608′ may alternatively be located at a different longitudinal and/or radial position on the bowl 352′. Bowl assembly 350′ and/or bowl 352′ maybe be the same or different than bowl assembly 350 and/or bowl 352, respectively.

Advantageously, the micro-puree machine 10 may include a sensor (not shown) that recognizes which lid is installed into the machine 10 to restrict certain programs based on the lid functions, which may prevent user error when operating the machine 10. For example, the micro-puree machine may only activate the blade 300 when the sensor detects that the bowl 352 is installed in the first configuration in which lid 440 is coupled to bowl 350 and may only activate the plunger 602 when the sensor detects that the bowl 352 is installed in the second configuration in which lid 440 is coupled to bowl 350. For example, each of lid 440 and 450 may include distinctive physical and/or electromagnetic features, e.g., as part of locating and locking elements 442 and 452, respectively, for which coupling 500 or other elements of the micro-puree machine 10 may be configured to detect and distinguish lid 440 from lid 450.

The housing 120 may house one or more motors and a transmission system (e.g., including gearing) that drive a driven shaft (e.g., driven shaft 250) for engaging the blade 300 and/or plunger 454 when the bowl assembly 350 (coupled to lid 440 or 450, respectively) is coupled to the housing for processing or extruding, respectively, for example, as described in the '765 patent or U.S. Pat. No. 11,882,965 to SharkNinja Operating LLC (the '965 patent), the entire contents of which are hereby incorporated by reference. For example, the one or more motors may include a first motor for driving rotation of the driven shaft 250 via the transmission, which may be used to drive the rotation of the blade 300 during processing, and, if desired (but not necessary) rotating the plunger 454 during extrusion. A second motor may be configured to move the position of the driven shaft 250, via the transmission, along its axis (e.g., back and forth; or up and down), which may be used to drive the back-and-forth movement of the blade 300 into and out of the bowl 350 during processing, and to move the plunger 454 into and out of the bowl 350 during extrusion. In embodiments, the micro-puree machine 10 may include gearboxes (e.g., high ratio gearboxes) and reinforced internals (not shown) to allow an extrusion assembly as described herein to withstand high forces and extrude thick outputs from the nozzle 608.

In some embodiments of the disclosure, a reversible bowl assembly may be used, which does not require that a lid be removed between processing and extruding. For example, the reversible bowl assembly may include: a first lid coupled at one end including a blade for processing and an opening for extruding; and a second lid at the other end including a plunger for extruding. Examples of such embodiments will now be described.

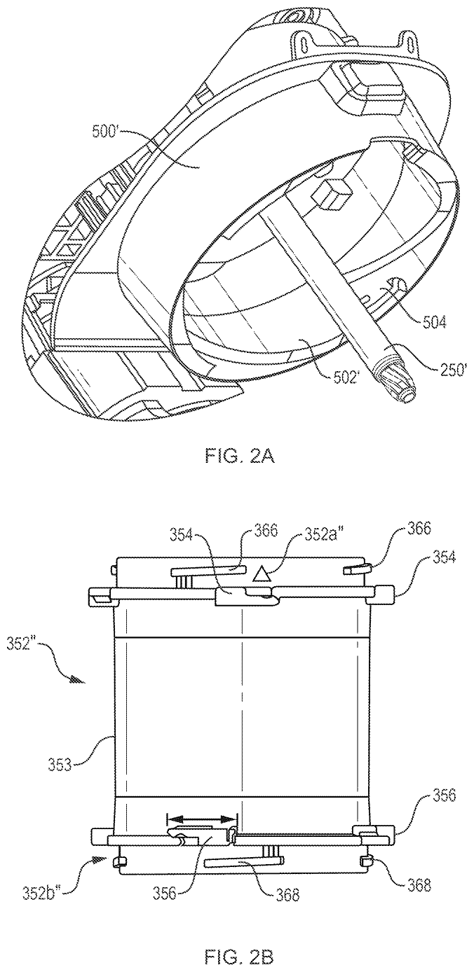

FIG. 2A illustrates an embodiment of a portion of a micro-puree machine including a coupling 500′for coupling to a bowl assembly, for example, a reversible bowl assembly, in accordance with some embodiments of the disclosure. FIG. 2B illustrates an embodiment of a reversible bowl 352″ that may be coupled to coupling 500′. The bowl 352″ may include any of a variety of external surfaces. For example, embodiments of the bowl may have a ribbed or corrugated surface (e.g., like bowl 352 or 352′), or a smooth surface (e.g., bowl 352″). Similarly, bowls 352 and 352″ may have any variety of surfaces, including smooth surfaces.

As shown in FIG. 2A, the driven shaft 250 of the micro-puree machine 10 may extend from the housing 120 into an interior of the coupling 500′and optionally all the way through the interior of the coupling 500′. The inner surface 502′of the coupling 500′may comprise one or more slots 504 sized and shaped to receive at least one projection 354 on an outer surface of a first open end 352a″ of the bowl 352″. In embodiments, both the first end 352a″ and the second end 352b″ of the bowl 352″ may be open-that is, both the first end 352a″ and the second end 352b″ may not have a top or bottom wall and/or a lid. However, the disclosure is not so limited, and one or both ends 352a″, 352b″ of the bowl 352″ may be closed with a wall or a lid. In embodiments, the at least one projection 354″ on the bowl 352″ may be four projections 354 spaced 90 degrees apart about an outer surface of the first end 352a″ of the bowl 352″. However, the disclosure contemplates more or fewer than four projections 354. In a first configuration of the reversible bowl assembly 350″, the user may rotate the bowl 352″ relative to the coupling 500′ such that the projections 354 are rotated into the slots 504, coupling (e.g., locking) the bowl 352″ and the coupling 500 together.

The slots 504 also may be sized and shaped to receive at least one projection 356 on an outer surface of a second open end 352b″ of the bowl 352″. In embodiments, the at least one projection 356 may be four projections 356 spaced 90 degrees apart about an outer surface of the second end 352b″ of the bowl 352″. However, the disclosure contemplates more or fewer than four projections 356. In a second configuration of the reversible bowl assembly 350″, the user may rotate the bowl 352″ relative to the coupling 500′such that the projections 356 are rotated into the slots 504, coupling (e.g., locking) the bowl 352″ and the coupling 500′together. The first end 352a″ of the bowl 352″ may further comprise threads 366 for coupling to a first lid, while the second end 352b″ of the bowl 352″ may comprise threads 368 for coupling to a second lid, as further described elsewhere herein.

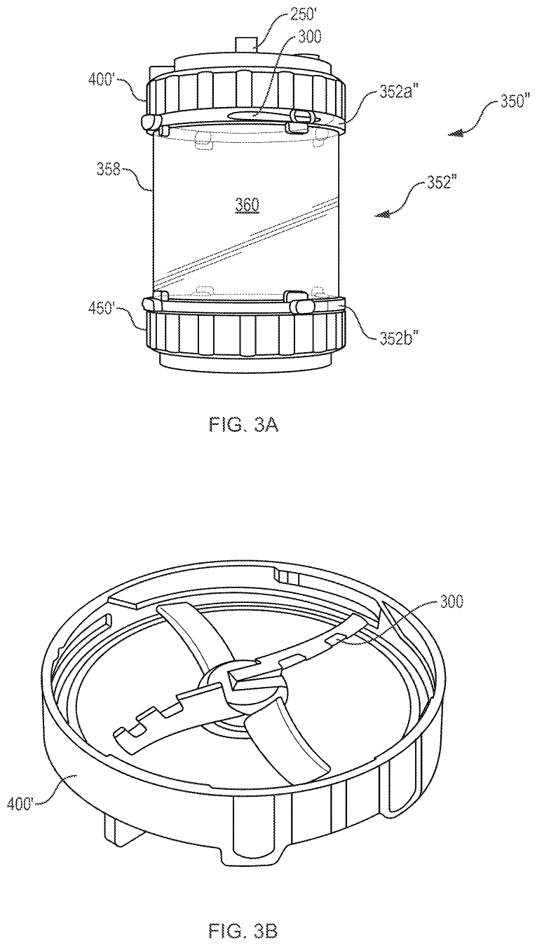

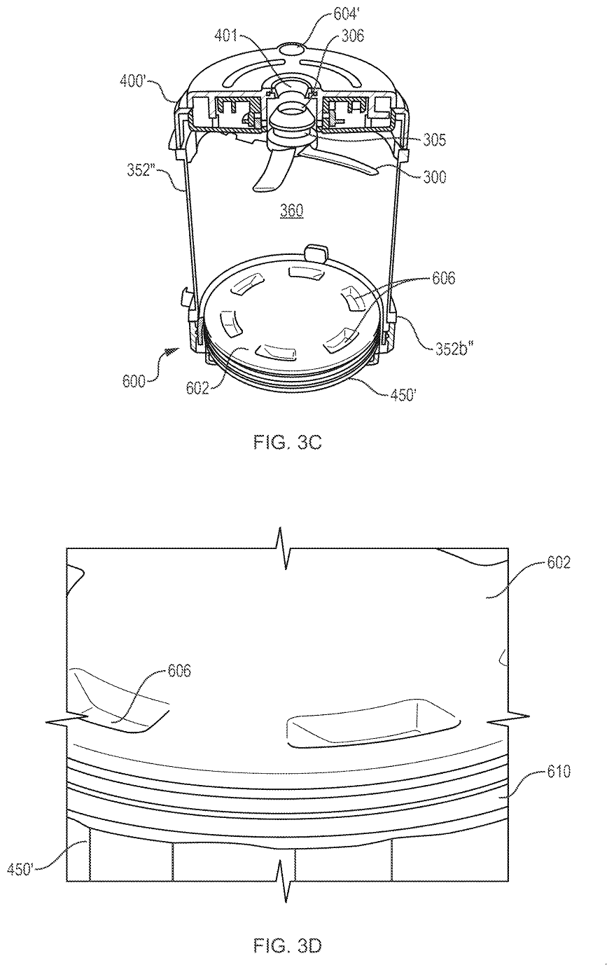

FIG. 3A shows an embodiment of the reversible bowl assembly 350″, assembled according to some embodiments of the disclosure. As shown in FIG. 3A, the bowl 352″ may have an oblong shape and include a cylindrical sidewall 358 defining an interior volume 360 of the bowl 352″. The sidewall 358 may extend between the first open end 352a″ of the bowl 352″ and the second open end 352b″ opposite the first open end 352a″. Embodiments of the sidewall 358 may have various configurations. For example, a cross-section of the sidewall may be circular or polygonal. In addition, a diameter of the sidewall may vary between the first open end 352a″ and the second open end 352b″ (e.g., may be tapered). The first open end 352a″ and the second open end 352b″ may communicate with the interior volume 360 of the bowl 352″. The assembly 350″ may further include a first lid 400′removably couplable to the first open end 352a″ of the bowl 352″. The first lid 400′may define an opening 401 (FIG. 3C) configured to couple to a blade 300 for mixing ingredients within the bowl 352″. When the bowl 352″ is installed to the coupling 500′in the first configuration, the blade 300 may engage with the driven shaft 250′to rotate and plunge the blade 300 within the ingredients. FIG. 3B shows an embodiment of the blade 300 coupled to the underside of first lid 400′. Some non-limiting examples of the blade 300 are shown in the '765 patent.

FIG. 3C is a cut-away view of the reversible bowl assembly 350″ and the first lid 400′, according to some embodiments of the disclosure, whereas blade 300 and a second lid 450′are not shown in cut-away form. As shown in FIG. 3C, the blade 300 may include a central support hub 305 including a central opening 306 for engaging the driven shaft 250. In embodiments, the second lid 450′may removably couple to the second open end 352b″ of the bowl 352″. The second lid 450′may include, or be coupled to, a plunger 602 for pushing the ingredients in the bowl 352″ toward an opening 604 in first lid 400′. The plunger 602, alone or in combination with other components (e.g., the second lid 450′, the bowl 352″, or the nozzle 608), may constitute an extrusion assembly 600 for extruding processed ingredients from the bowl 352″. The opening 604′ in the first lid 400′may further be in fluid communication with a nozzle (e.g., nozzle 608). For example, the opening 604′may be in fluid communication with a nozzle through a conduit (e.g., plastic tubing) that extends from the opening 604′to the nozzle. In embodiments, such a conduit may include one or more sections connected by joints (e.g., an elbow joint) to translate the direction (e.g., horizontal) of extrusion from opening 604 to a direction (e.g., vertically downward) of extrusion from the nozzle.

The plunger 602 may be couplable to the driven shaft 250′of the micro-puree machine when the bowl assembly 350″ is in the second configuration and the bowl 352″ is installed to the coupling 500′. A surface of the plunger 602 facing the interior volume 360 may include a one or more (e.g., a plurality of) indentations 606. The indentations 606 may prevent frozen ingredients from rotational movement within the bowl 352″ during processing by the blade 300. The plunger 602 may furthermore include a flexible seal 610 around its perimeter to ensure contact (e.g., maximum contact) with the sidewall 358 of the bowl 352″ to allow for optimal (e.g., maximum) extrusion yield.

The micro-puree machine of the embodiments described in relation to FIGS. 2A, 2B, 3A-3D, 4B and 4B may include one or more motors and a transmission system (e.g., including gearing) that drive a driven shaft (e.g., driven shaft 250′) for engaging the blade 300 and/or plunger 602 when the bowl assembly 350″ (coupled to lid 400′or 450′, respectively) is coupled to the housing for processing or extruding, for example, as described in the '765 patent or the '965 patent; and may include gearboxes (e.g., high ratio gearboxes) and reinforced internals (not shown) to allow the extrusion assembly 600 to withstand high forces and extrude thick outputs from a nozzle.

FIG. 3D shows a detailed view of an embodiment of the plunger 602 coupled to the underside of second lid 450′. In embodiments, the bowl assembly 350″ may be configured such that only the first lid 400′can couple to the first open end 352a″ of the bowl 352″ and only the second lid 450′can couple to the second open end 352b″ of the bowl 352″. For example, a configuration of the threads 366 may be different from a configuration of the threads 368 (FIG. 3B) to prevent the user from attaching the wrong lid to the wrong side of the bowl 352″. The bowl 352″ may further include clear indicators (colors, icons, etc.) that would signal to the user which lid goes on which side of the bowl 352″.

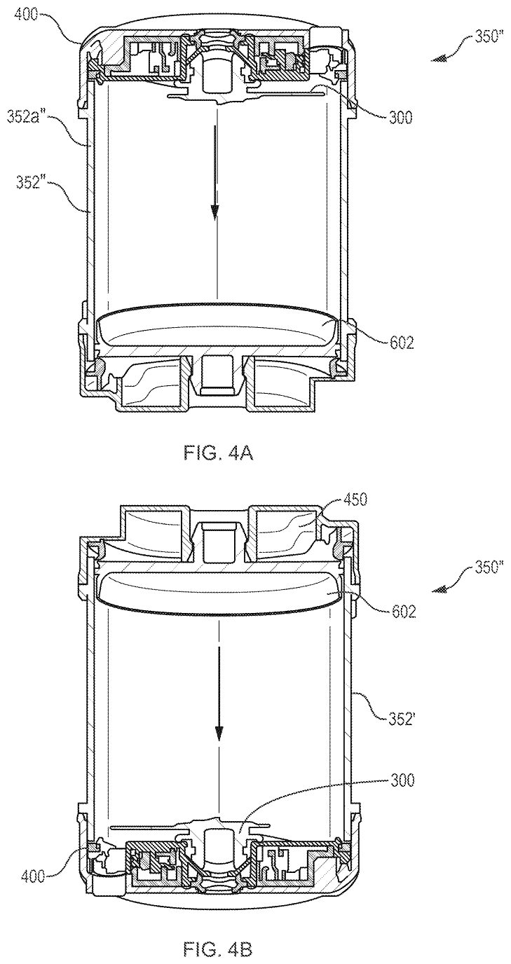

FIGS. 4A and 4B illustrate the use of the reversible bowl assembly 350″ according to some embodiments of the disclosure. As shown in FIG. 4A, a user may first install the bowl assembly 350″ to the micro-puree machine 10 in the first configuration such that the first end 352a″ of the bowl 352″ is secured to the coupling 500′. The user then may select a program at the user interface depending on the desired output (for example, soft serve ice cream, light ice cream, sorbet, gelato, etc.) to spin and plunge the blade 300 into the ingredients in the bowl 352″. For example, the blade 300 may descend into the ingredients and then ascend from the ingredients at one or more predefined rates, while rotating at one or more predefined rates. As shown in FIG. 4B, the user then may then remove the bowl assembly 350″ from the coupling 500′, reverse the orientation of the bowl assembly 350″ (i.e., flip the bowl assembly 350″) and reinstall the second end 352b″ of the bowl 352″ to the coupling 500′in the second configuration. The user then may select a desired program at the user interface to descend the plunger 602 to extrude the ingredients out through the opening 604′in the first lid 400′. For example, the plunger 602 may descend into the ingredients to extrude the ingredients out through the opening 604′and then ascend from the opening 604′after the extrusion is complete.

While embodiments of the disclosure include performing processing and extrusion using a same driven shaft, in some embodiments, processing and extrusion are performed on different shafts, as will now be described.

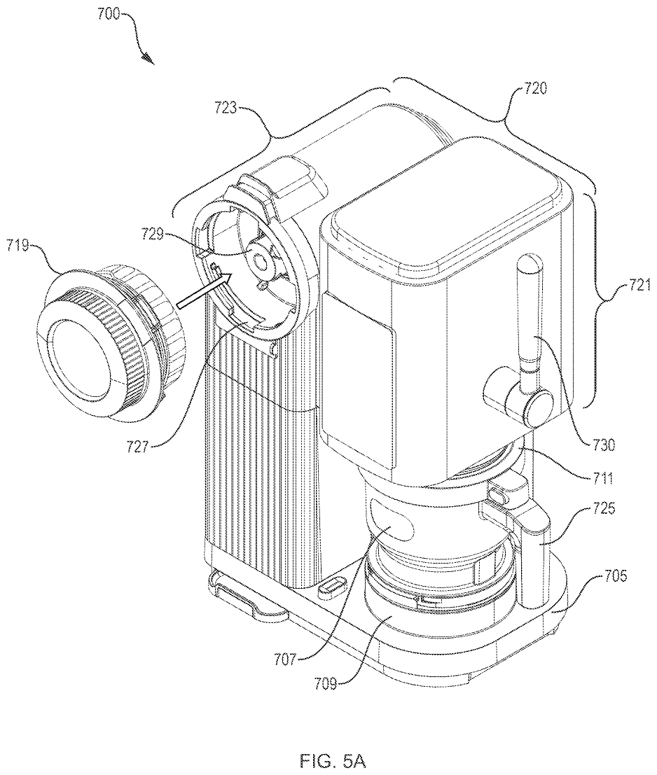

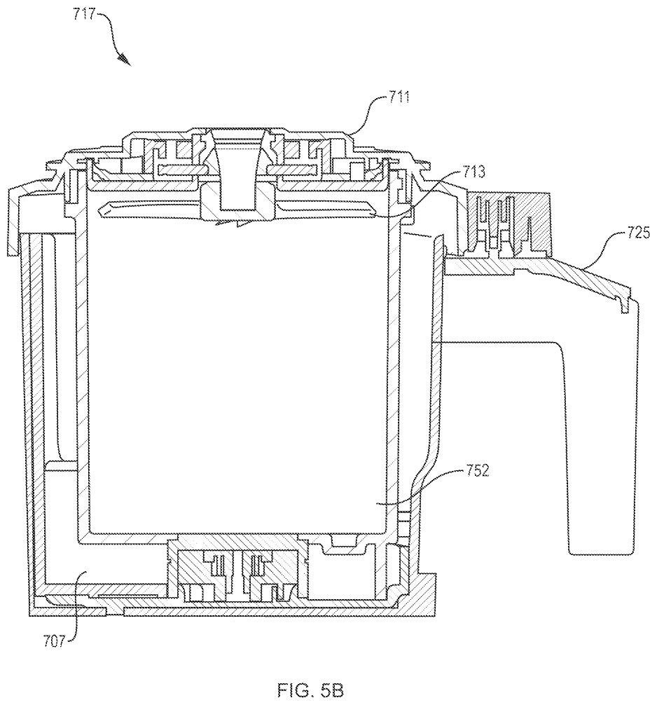

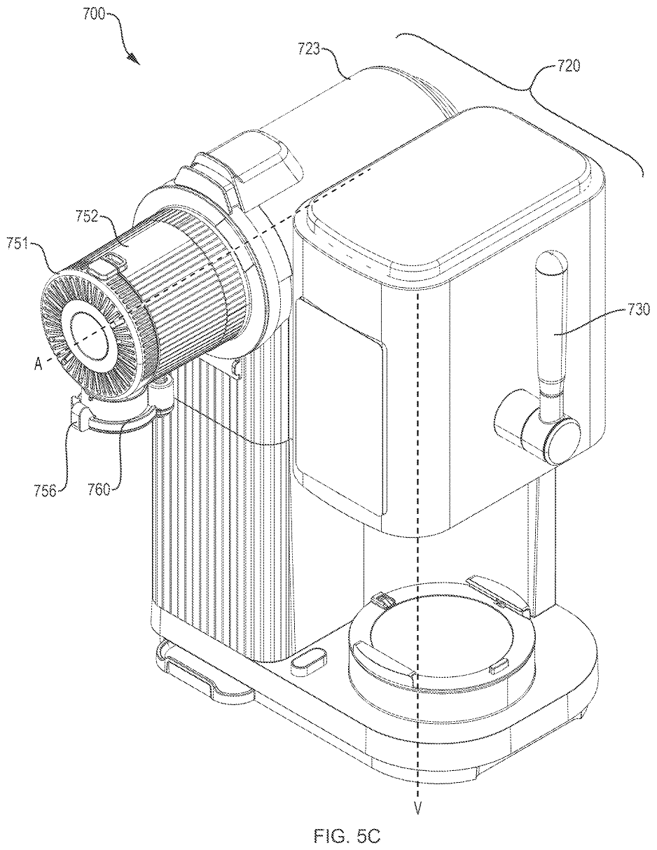

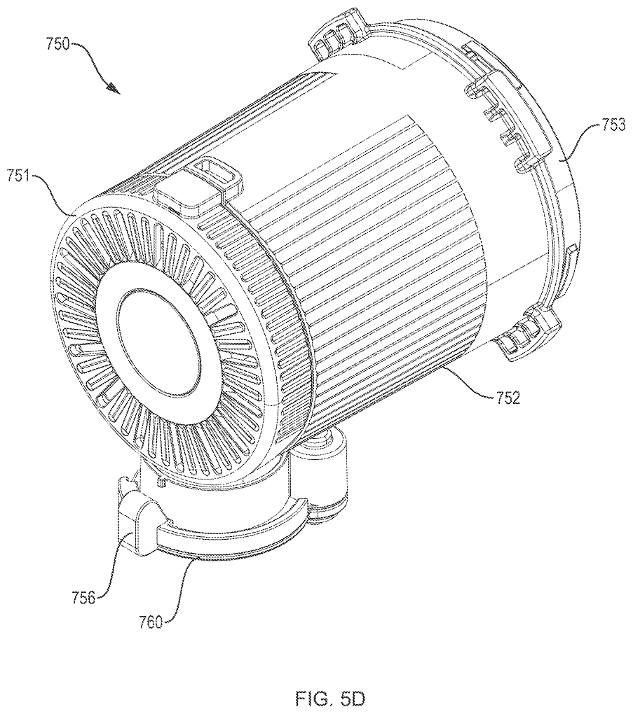

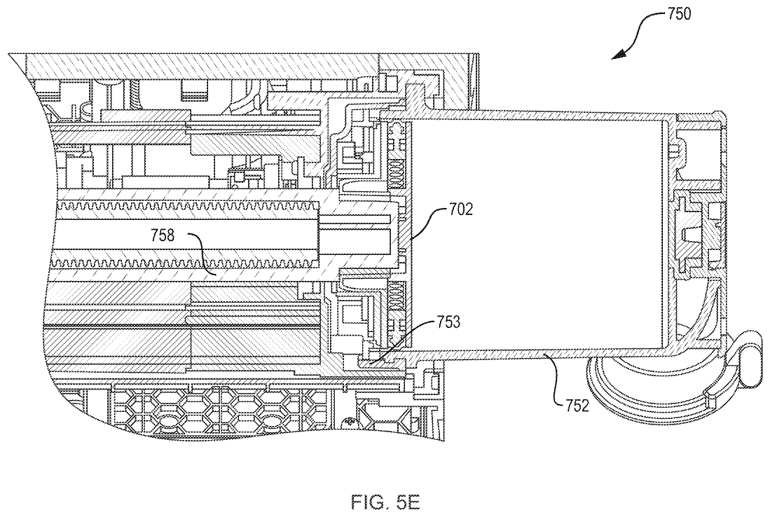

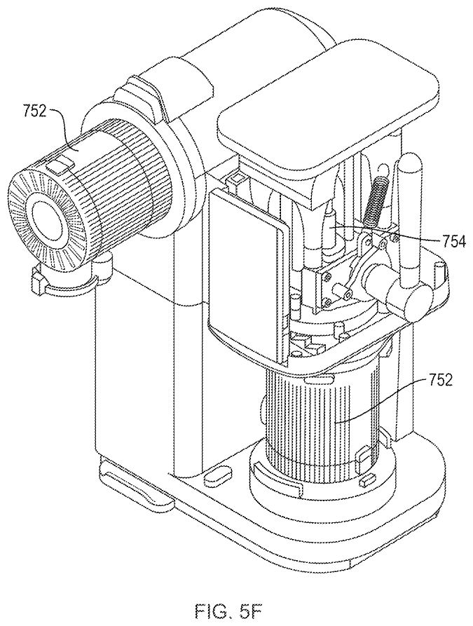

FIGS. 5A-5F illustrate another micro-puree machine 700, according to some embodiments of the disclosure. FIGS. 5A and 5B illustrate an embodiment of micro-puree machine 700 in a first configuration for processing (e.g., micro-pureeing), which may be referred to herein as a processing configuration. FIGS. 5C-5E illustrate an embodiment of micro-puree machine 700 in a first configuration for extruding, which may be referred to herein as an extruding or extrusion configuration. FIG. 5E illustrates an embodiment of micro-puree machine 700 in both processing and extruding configurations merely for illustrative purposes, as in some embodiments, the micro-puree machine 700 is not configured to perform processing and extruding concurrently.

As shown in FIGS. 5A and 5B, the micro-puree machine 700 may include a base 705 and a housing 720. The housing 720 may include a user interface (not shown) for receiving user inputs to control the micro-puree machine 700 and/or display information. In some embodiments, the micro-puree machine includes a processing sub-module 721 including one or more components configured to process ingredients in a bowl 752 (e.g., bowl 352 or a variation thereof) and an extruding sub-module 723 including one or more components configured to extrude processed ingredients from the bowl 752. In a processing configuration, the bowl 752 may be coupled to the interior of an outer bowl 707 that is mounted on a processing platform 709 mounted to the base 705. The bowl 752 may be coupled to a lid 711 (e.g., lid 442 or a variation thereof) that houses a blade 713 (e.g., blade 300 or a variation thereof). The bowl 752 may include a nozzle control assembly 751 (e.g., a dial) that enables a user to control an opening or closing of a nozzle 760, a nozzle 760, and a hinged stopper or plug 756 that can be used by a user to selectively cover the nozzle 760, or the nozzle control assembly 751. In some embodiments, the nozzle control assembly 751, the nozzle 760, and the stopper 756 may be removably attachable to the bowl 752. Using the handle 725, a user may rotate and elevate the processing bowl assembly 717 into a processing position in which the blade 713 engages with a driven shaft 754, the lid 711 couples to the micro-puree machine 700, and the blade 713 is released from the lid 711 so that the driven shaft 754 can drive the shaft 754, for example, as described in the '765 patent. By engaging the user interface (or via a remote interface wirelessly connected to a wireless interface within housing 720), the user may initiate processing of the ingredients in the bowl 752. In a processing configuration, extruding sub-module 723 may remain idle, and a cap or plug 719 may be coupled to a coupling 727, covering an interface 729 with driven shaft 758. The coupling 727 (e.g., coupling 500) also may serve as a coupling between the bowl assembly 750 (e.g., the lid 753 of the bowl assembly 750) and the micro-puree machine 700. After the processing of the ingredients, the processing bowl assembly 717 may be decoupled from the micro-puree machine 710 (e.g., from the processing sub-module 721), and de-mounted from the platform 709. The lid 711 may be removed from the outer bowl 707, and the bowl 752 may be removed from the outer bowl 707.

As shown in FIGS. 5C-5E, a lid 753 then may be mounted to the bowl 752, and the bowl 752 then may be coupled to the micro-processing machine 710 (e.g., to the extruding sub-module 723) in an extruding configuration. In the extruding configuration, the bowl 752 may be coupled to a lid 753 (e.g., lid 452 or a variant thereof) that includes a plunger 702. The combination of the bowl 752 and the lid 753 may be referred to herein as a bowl extruding assembly 750. In embodiments, the bowl extruding assembly 750 may be configured to be installed to the micro-puree machine 700 such that the nozzle 760 faces vertically downwards when the bowl extruding assembly 750 is properly installed. The bowl extruding assembly 750 may be assembled to the housing 720 (e.g., the extruding sub-module 723) such that a central axis A of the bowl extruding assembly 750 extends perpendicular to a vertical axis V of the housing 720, as shown. The bowl extruding assembly 750 may include an outlet 760 for extruding processed ingredients from the bowl extruding assembly 750. The micro-puree machine 700 also may include a lever 730 for manually activating a plunger 702 to extrude processed ingredients within the bowl extruding assembly 750 through the outlet 760. While the lever 730 is illustrated on a right side of the machine 700 (from the front view shown in FIG. 5C), the disclosure is not so limited. The lever 730 may be on the left side of, or another location on, the machine 700, and other components of the machine may be rearranged to accommodate the different location of the lever 730. The housing 720 may include electrical, electromagnetic, mechanical and/or electro-mechanical components to translate a pulling down or pushing up of the lever 730 into movement of the plunger 702 within the bowl 752.

Embodiments of the housing 720 of micro-puree machine 700 may house a transmission system that includes a driven shaft 754 for engaging the blade 713, a separate driven shaft 758 for engaging the plunger 702, one or more gearing systems, and one or more position and/or drive motors for moving the driven shaft 754 and the other shaft 758 rotationally and/or axially to process the ingredients in the bowl assembly 750. For example, a drive motor may drive the rotation of the driven shaft 754 and blade (e.g., blade 300) coupled thereto, and a position motor may drive the vertical (e.g., down and up) movement of the driven shaft 754 and a blade. Another motor may drive the second shaft 758 and a plunger (e.g., plunger 454 or 602) attached thereto. In embodiments, the blade 713 may be programmably controlled at the user interface by a computing system to operate at different rotational speeds and move up and down in different patterns and speeds, and for different periods of time, to make different food items. In embodiments, the plunger 702 in the lid 753 may be programmably controlled at the user interface by a computing system to operate at different rotational speeds (although rotation is not necessary for extruding) and move up and down in different patterns and speeds, and for different periods of time. Some non-limiting examples of a transmission system and the computing system are shown in described in the '765 patent and in U.S. Pat. No. 11,882,965 to SharkNinja Operating LLC (the '965 patent), the entire contents of which are hereby incorporated by reference.

In some embodiments of the disclosure, a nozzle control assembly for a micro-puree machine (or other device for processing and/or extruding food) is provided for controlling the nozzle by which processed ingredients can be extruded from a bowl, as will now be described.

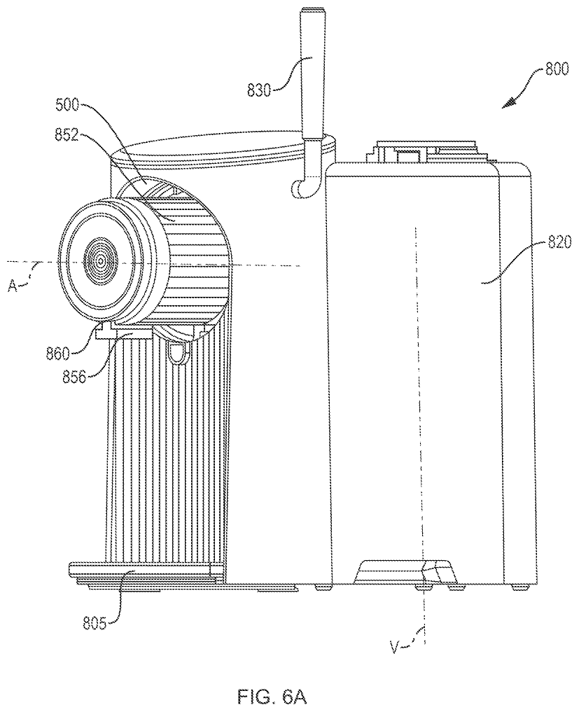

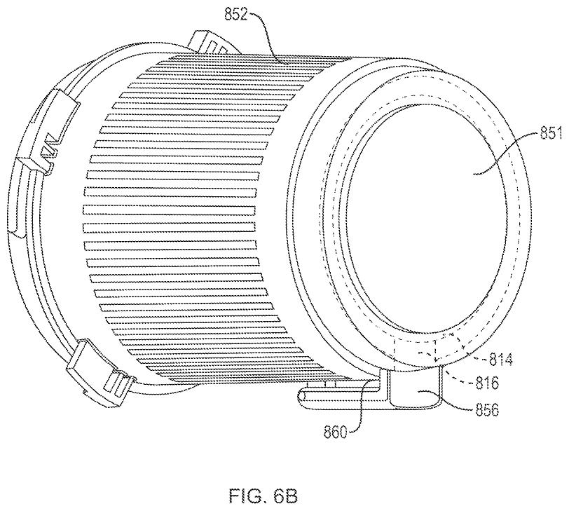

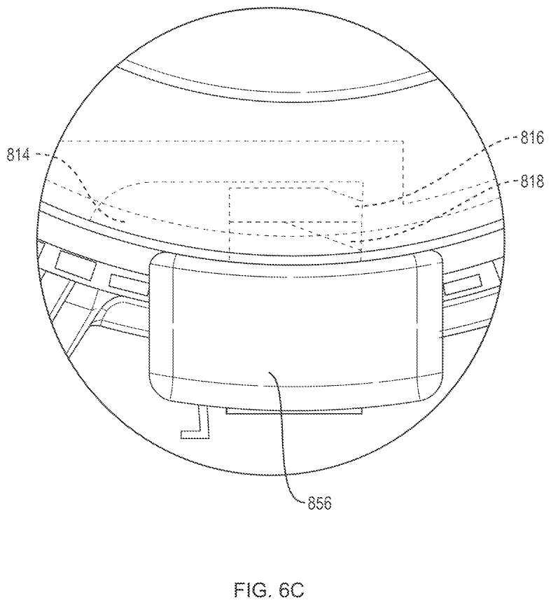

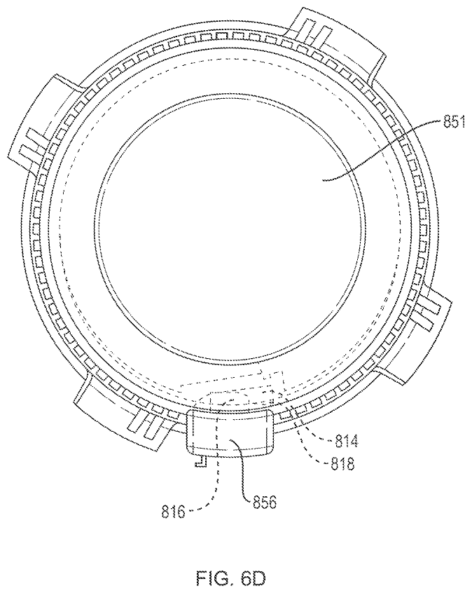

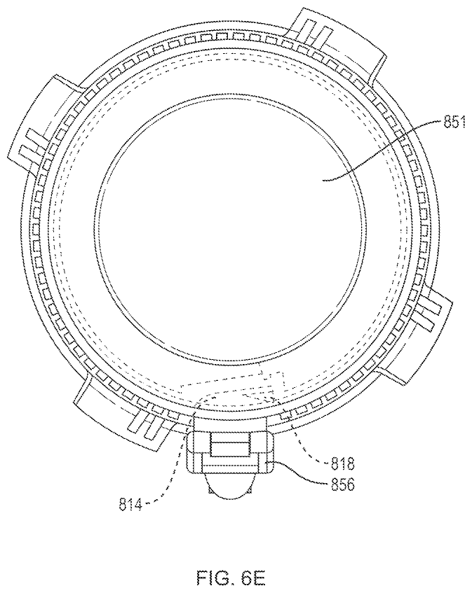

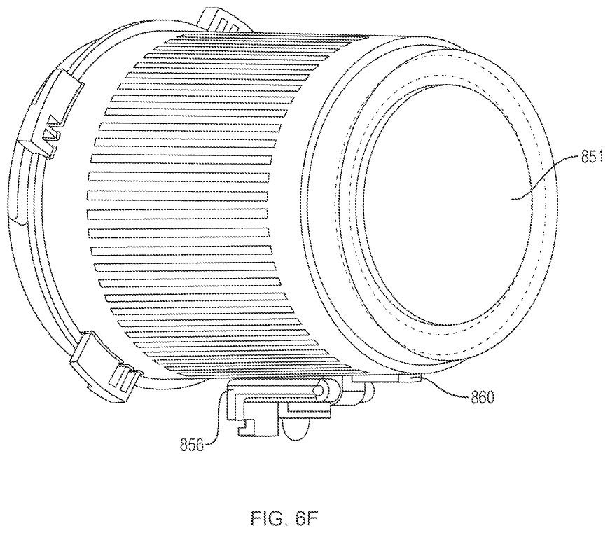

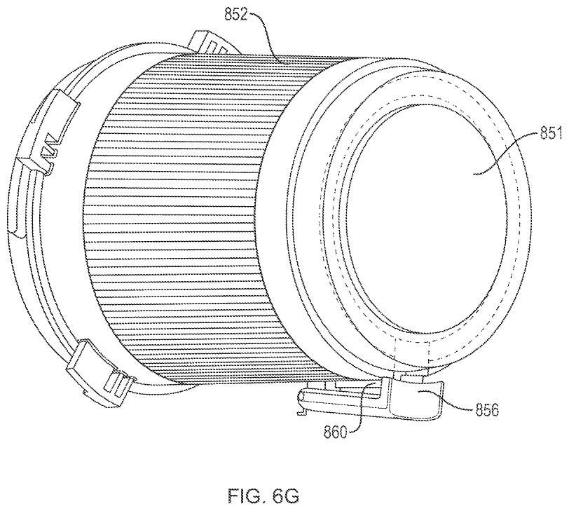

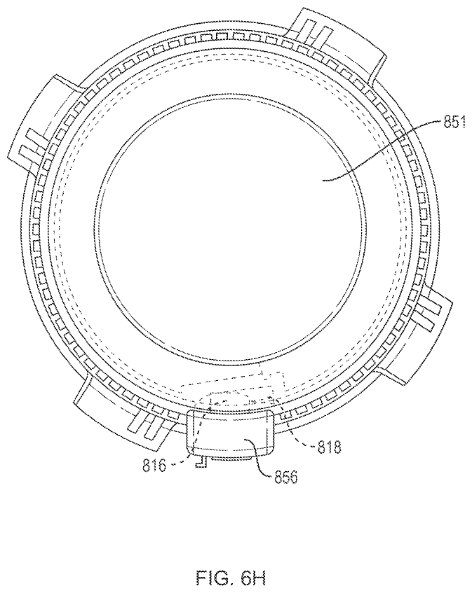

FIG. 6A illustrates another micro-puree machine 800 that performs processing and extrusion using a same driven shaft, according to some embodiments of the disclosure. While embodiments of a nozzle control assembly are described in relation to a micro-puree machine (e.g., machine 800) that performs processing and extrusion using a same driven shaft, it should be appreciated that the disclosure is not so limited. A nozzle control assembly as described herein can be implemented on a micro-puree machine in which processing is performed on a first driven shaft and extrusion is performed on a second driven shaft or on another type of device for processing food. The micro-puree machine 800 may include a base 805 and a housing 820. The housing 820 may include a user interface (not shown) for receiving user inputs to control the micro-puree machine 800 and/or display information. The micro-puree machine 800 may also include the bowl 852. The bowl 852 may be assembled to the housing 820 such that a central axis A of the bowl 852 extends perpendicular to a vertical axis V of the housing 820, as shown. However, the disclosure contemplates that the bowl 850 may be assembled to the housing 820 such that the central axis A extends at an angle of between 0 and 90° to the vertical axis V, or such that the central axis A extends parallel to the vertical axis V. The micro-puree machine 810 may also include a lever 830 for activating the plunger (e.g., plunger 602) to extrude processed ingredients within the bowl 852 through a nozzle 860. The nozzle 860 may be integrated with the bottom edge of the bowl 852 and may be coverable with a hinged stopper or plug 856. In embodiments, the bowl 852 may be configured to be installed to the coupling (e.g., coupling 500) such that the nozzle 860 faces vertically downwards when the bowl 852 is properly installed. The nozzle 860 may be selectively located on the bowl 852 to optimize the amount of processed ingredients that can be extruded, thus minimizing the amount of yield loss after extrusion. For example, the nozzle 860 may be located near the bottom edge of the bowl 852, as shown in FIG. 6A. However, the disclosure also contemplates that the nozzle 860 may alternatively be located at a different longitudinal and/or radial position on the bowl 852.

FIG. 6B illustrates a nozzle control assembly including a rotatable dial 851 for use with the micro-puree machine 800, according to some embodiments of the disclosure. In this embodiment, the plug 856 may be biased to an open position (e.g., spring-loaded). The plug 856 may be held and locked into the closed position through engagement of an L-shaped tab 816 on the plug 856 with an internal CAM path 814 on the dial 851. The dial 851 may also be biased (e.g., spring loaded) in a first rotational direction (e.g., clockwise). To open the plug 856, the user may rotate the dial 851 in a rotational direction (e.g., counterclockwise), causing the plug 856 to be released from the CAM path 814 and sprung into the open position, as further described elsewhere herein. When the plug 856 is in the open position, the user may extrude the processed ingredients through the nozzle 860.

FIGS. 6C-6I illustrate the opening and closing of the plug 856 according to some embodiments of the disclosure. As shown in FIG. 6C, when the plug 856 is in the closed position, the tab 816 may be held within the CAM path 814 by a ramp 818. As shown in FIG. 6D, to open the plug 856, the user may rotate the dial 851 in the second rotational direction, causing the tab 816 to slide off the ramp 818 and disengage from the CAM path 814. As shown in FIG. 6E, when the tab 816 disengages from the CAM path 814, the plug 856 may automatically spring into the open position, exposing the nozzle 860 (FIG. 6F). The user may then release the dial 851 so that it springs automatically clockwise back to the home position. As shown in FIG. 6G, to close the plug 856 after extrusion of ingredients from the bowl 852, the user may manually push the plug 856 back into engagement with the nozzle 860. As shown in FIG. 6H, when the plug 856 is pushed back into engagement with the nozzle 860, the tab 816 on the plug 856 may again engage the ramp 818, causing the dial 851 to move slightly counterclockwise. As shown in FIG. 6I, once the tab 816 has moved past the ramp 818, the dial 851 may again be free to rotate clockwise, locking the plug 856 into the CAM path 814.

The disclosure further contemplates that, to prevent users from sticking their fingers into the bowl 852 through the nozzle 860 during extrusion, a cross rib (not shown) may be placed over the nozzle 860. Additionally, a magnet (not shown) in the hinged plug 856 may interact with a reed switch in the housing 820 when the plug 856 is in the open position to allow the machine 800 to detect whether the plug 856 is open or closed. The machine 800 may further be configured to prevent processing programs from running when the plug 856 is determined to be open.

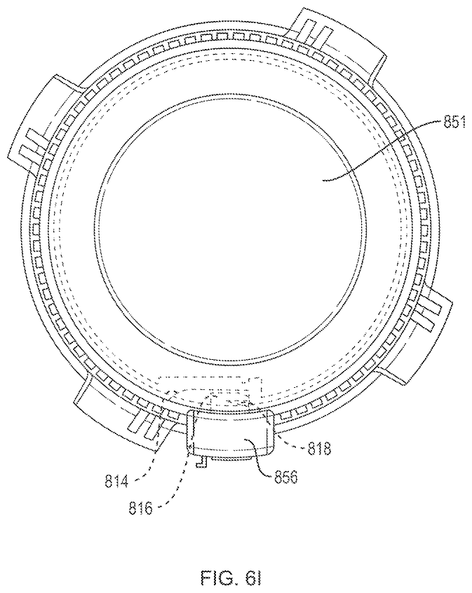

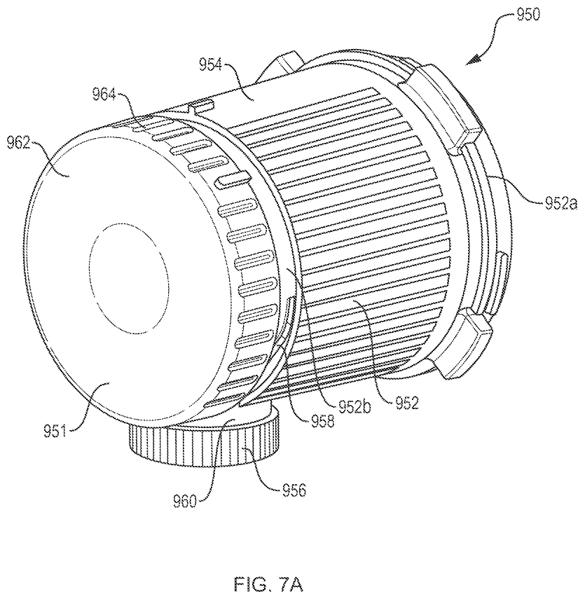

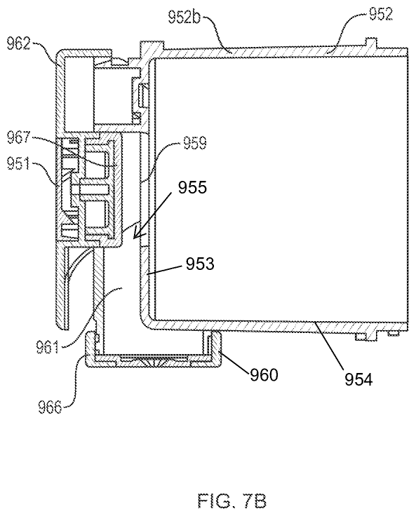

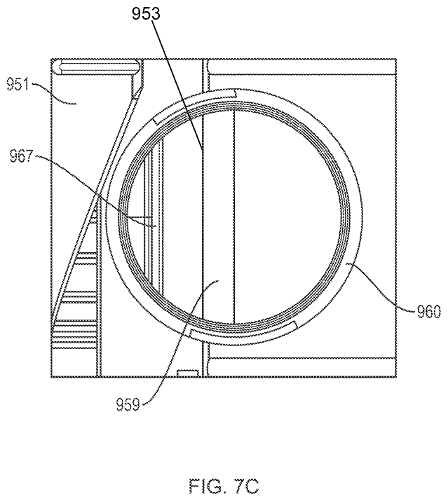

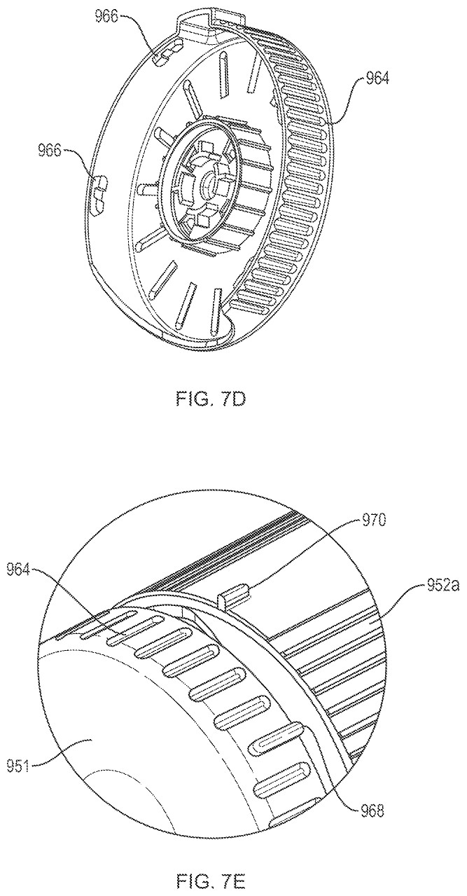

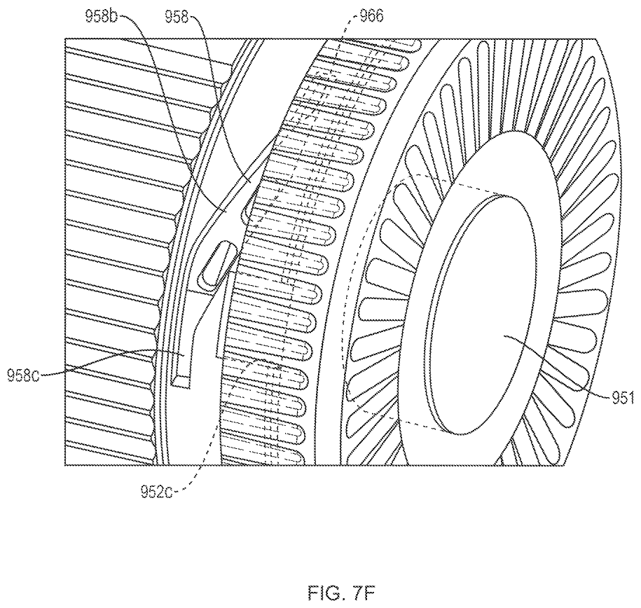

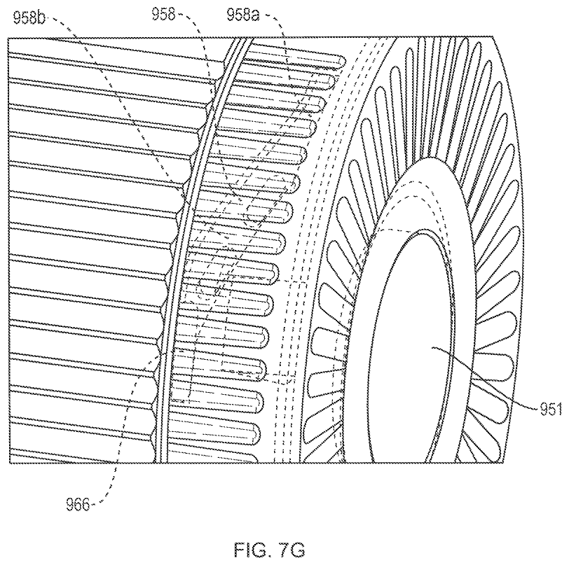

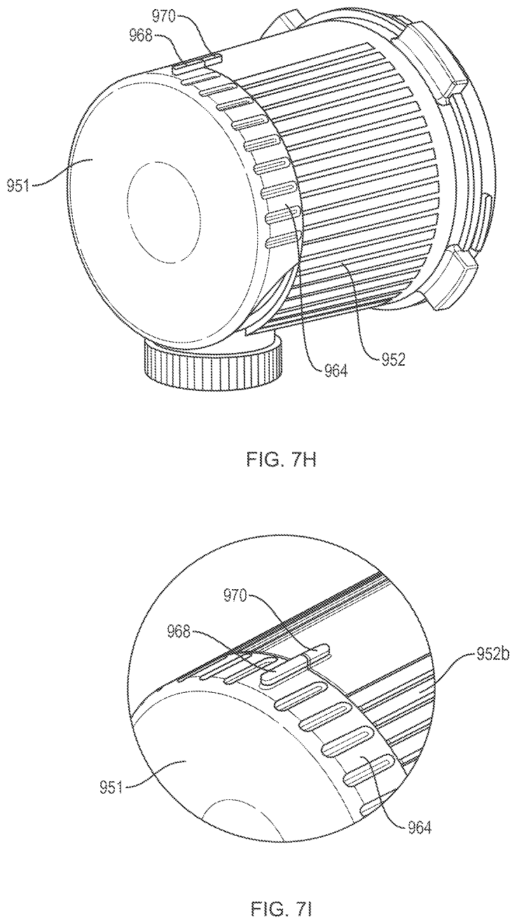

FIGS. 7A-7J illustrate another nozzle control assembly including a rotatable dial 951 for use with a micro-puree machine (e.g., micro-puree machine 700), according to some embodiments of the disclosure. FIGS. 7A-7F illustrate various aspects of the dial 951 in an open position, while FIGS. 7G-7J illustrate the dial 951 in a closed position.

As shown in FIG. 7A, a bowl assembly 950 may include a bowl 952 having a first end 952a for coupling to a lid (e.g., lid 753) and a second end 952b. A sidewall 954 may extend between the first end 952a and the second end 952b and define an interior volume of the bowl 952. The second end 952b of the bowl may include a nozzle 960. An outer surface of the second end 952b may define at least one cam track 958 extending at least partially around the second end 952b, as described elsewhere herein. The dial 951 may be configured to rotate about the second end 952b of the bowl 952. The dial 951 may be permanently affixed to the second end 952b of the bowl 952 or the dial 951 may be completely removeable from the bowl 952.

The dial 951 may comprise a bottom wall 962 and a sidewall 964 extending from the bottom wall 962. The sidewall 964 may be configured to cover the second end 952b of the bowl 952 when the dial 951 is assembled to the bowl 952. As shown in FIG. 7B, the second end 952b of the bowl 952 may have at least one opening 959 in communication with the interior volume of the bowl 952 and with a channel 961 of the nozzle 960. An interior surface of the bottom wall 962 may further include a seal 967 for sealing the channel 961 when the dial 951 is in a closed position. The nozzle 960 may further include a stopper or cap 956 that can be used by a user to selectively cover a nozzle 960 when not in use. The cap 956 may include interior threading (not shown) or other coupling features that allow it to couple to the nozzle 960. As shown in FIG. 7C, when the dial 951 is in the open position, a space between the seal 967 and the opening 959 may be wide enough to allow for easy extrusion of frozen ingredients through the nozzle 960, while also narrow enough to prevent a user from inserting their fingers into the nozzle 960.

As shown in FIG. 7D, an interior surface of the sidewall 964 may have at least one engagement feature (e.g., a pin 966) for engaging and sliding along the cam track 958. The number of pins 966 may be selected to be the same as the number of cam tracks 958 on the bowl 952. For example, the number of pins 966 may be four pins 966 corresponding to four cam tracks 958, as shown. However, the disclosure contemplates that the number of pins 966 may differ from the number of cam tracks 958. As shown in FIG. 7E, an outer surface of the sidewall 964 may include a first rib 968 configured to align with a second rib 970 on the second end 952b of the bowl 952 when the dial 951 is in the closed position.

FIGS. 7F and 7G illustrate the rotation of the pins 966 into the cam track 958, according to some embodiments of the disclosure. In FIGS. 7E and 7F, the dial 951 is shown in a transparent view for ease of illustration. The cam track 958 may comprise a first portion 958a that extends substantially parallel to a bottom edge 952c of the bowl 952, a second portion 958b that extends at an angle with respect to the bottom edge 952c, and a third portion 958c that also extends substantially parallel to the bottom edge 952c. In the open position of the dial 951, the pin 966 may be positioned within the first portion 958a of the cam track 958. As the user rotates the dial 951 (e.g., counterclockwise), the pin 966 may slide within the second portion 958b into the third portion 958c of the cam track 958. A width of the third portion 958c may be selected such that an interference fit is formed between the pin 966 and the third portion 958. As such, the dial 951 is prevented from opening during freezing and processing of the ingredients in the bowl 952 until a force is exerted on the dial 951 sufficient to move the pin 966 out of the third portion 958c.

FIGS. 7H-7J illustrate the dial 951 in the closed position, according to some embodiments of the disclosure. As shown in FIGS. 7H and 7I, when the dial 951 is in the closed position, the first rib 968 on the sidewall 964 of the dial 951 may align with the second rib 970 on the second end 952b of the bowl 952. In this way, a user may visually verify that the dial 951 is in the fully closed position and that the bowl 952 is completely sealed before freezing the ingredients within the bowl or beginning the extrusion process. Furthermore, as shown in FIG. 7J, when the dial 951 is in the fully closed position, the seal 967 may close the opening 959 in the bowl 952, thus also sealing the channel 961 of the nozzle 960. The sealing of the channel 961 may prevent the inadvertent extrusion of ingredients from the bowl 952 during freezing and processing. Advantageously, a diameter of seal 967 may be selected to be sufficiently large such that an ice wall formed in the ingredients during freezing may be broken by the unsealing of the seal 967 from the opening 959.

With reference to FIGS. 7B, 7C, and 7J, according to some embodiments of the present disclosure, the bowl 952 may include an access restraint member 953 provided to prevent access, either directly or indirectly, into the interior of the bowl 952. The access restraint member 953 may be provided to prevent individuals, especially younger children, from inserting their fingers or other objects through the nozzle 960 (also referred to as an “outlet”) and into the interior of the bowl 952 during an extrusion process of the micro-puree machine 700. In some embodiments, an individual may inadvertently or intentionally insert a finger or a larger object into the channel 961, such as when an individual may attempt to clean or remove an obstruction from the channel 961. In the event this occurs during the extrusion process, the access restraint member 953 is provided to prevent and obstruct the individual's finger or larger object from moving into the interior of the bowl 952 or prevents and obstructs exterior access to the interior volume of the bowl 952, where the individual's finger or larger object may make contact with the plunger 602, thereby either causing harm to the individual's finger, the larger object, and/or the plunger 602. It is also contemplated that the sidewall 954 of the bowl 952 may also assist in blocking larger objects from accessing the interior volume of the bowl 952. The access restraint member 953 may be made of the same material as the sidewall 954 of the bowl 952.

With continued reference to FIGS. 7B, 7C, and 7J, according to some embodiments of the present disclosure, the access restraint member 953 may be a wall or structure that extends inwardly from the sidewall 954 of the bowl 952. In some embodiments, the access restraint member 953 may be formed integral with the second end 952b of the bowl 952. In some embodiments, the access restraint member 953 may be a separate component otherwise connected to the sidewall 954 of the bowl 952 using any conventional methods for connection, including welding, adhesive, screws, or any other methods to connect two components to one another. The access restraint member 953 may extend substantially perpendicular to the sidewall 954 of the bowl 952. In some embodiments, the access restraint member 953 extends from an end of the second send 952b of the bowl 952 that is most adjacent to the nozzle 960. The access restraint member 953 may extend substantially parallel to the channel 961 and may extend from the sidewall 954 of the bowl 952 to a location adjacent to the seal 967 of the dial 951.

As shown in FIG. 7B, when the dial 951 is in the open position, the at least one opening 959 is open and free to direct ingredients or food through the channel 961 and out through the nozzle 960, while the access restraint member 953 prevents an individual from inserting any object through the channel 961 and into the interior of the bowl 952. The gap 955 established between the seal 967 and the access restraint member 953 is small enough to prevent any object from passing through the gap 955 and into the interior of the bowl 952, while being large enough to still allow the ingredients to be extruded from the bowl 952 through the channel 961 and the channel 960. As shown in FIG. 7J, when the dial 951 is in the closed position, the at least one opening 959 is closed by the seal 967 and prevents any ingredients or food being directed through the channel 961 and out through the nozzle 960, while the access restraint member 953 continues to prevent an individual from inserting any larger object through the channel 961 and into the interior of the bowl 952. In the closed position, the seal 967 may abut the access restraint member 953 to close the at least one opening 959. In one embodiment, the gap 955 measures between 0.5 cm and 1.5 cm. However, it is contemplated that this gap 955 may be smaller or larger than this indicated range.

The disclosure contemplates that, in some embodiments, the bowl from which ingredients are processed and/or extruded (e.g., bowl 352, 352′, 352″, 752, 852, 952) can be coupled vertically in an inverted orientation (i.e., downward) on a top or upward-facing surface of the housing (e.g., housing 120, 720) of a micro-puree machine (e.g., micro-puree machine 10, 700) whereby the blade (e.g., blade 300, 713) moves up and then down to creamify, process, and/or mix ingredients in the bowl. The upward-facing surface may face vertically upward or be angled in an upward direction. In some embodiments, the micro-puree machine may be configured to automatically detect a size of the bowl and, in response to the detection, extend the blade a depth and/or travel distance into the bowl based on the detected size of the bowl. This bowl-size detection would advantageously enable the micro-puree machine to process ingredients in different sized containers, such as a single serve container or larger containers.

The disclosed micro puree machine may include a force limiting mechanism provided with the bowl 952 to reduce the amount of force that can be applied to various components of the extrusion assembly. As previously described, the extrusion assembly may include a lever that can be manipulated by a user to extrude contents within the bowl 952 using a plunger 702. Movement of the plunger 702 is controlled by a drive train. If the contents within the bowl 952 are too hard, damage can occur when extruding or attempting to extrude the contents of the bowl 952. To protect the drive train and other componentry of the extrusion assembly, a force limiting mechanism may be provided with the bowl 952 to selectively restrict or eliminate input force applied to the lever from transferring to the extrusion drive train (and activating the plunger 702). The disclosed force limiting mechanism may be used in connection with any extrusion assembly described herein. Limiting the amount of force that can be exerted on the drive train can advantageously prevent damage and extend lifetime of the drive train and other components of the extrusion assembly.

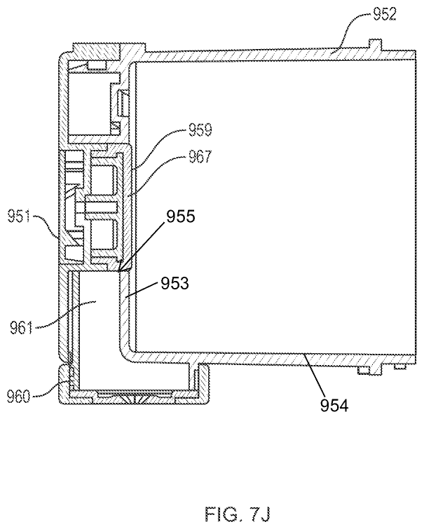

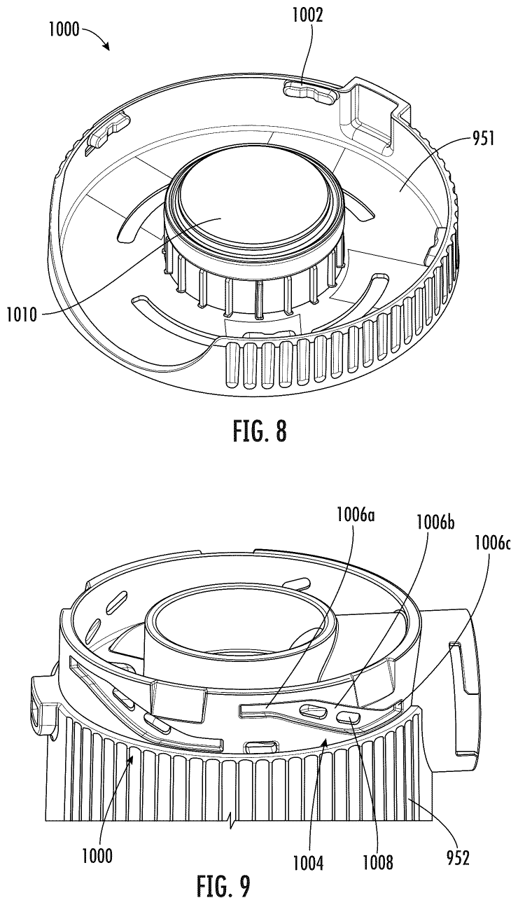

The force limiting mechanism may be implemented using various mechanical mechanisms. For example, the force limiting mechanism may be configured to mechanically divert force applied to the lever from the extrusion drive train if a force limit is exceeded. FIGS. 8-13 illustrate a force limiting mechanism 1000 that is provided on the bowl 952.

With reference to FIG. 8, according to one non-limiting embodiment or aspect of the present disclosure, a force limiting mechanism 1000 is provided on the bowl 952 for a micro-puree machine. In some examples, the force limiting mechanism 1000 is provided on the dial 951 and the exterior surface of the bowl 952. The force limiting mechanism 1000 may include at least one tab 1002 that extends from an inner surface of the dial 951. In some examples, at least two tabs 1002 are positioned around the inner circumference of the dial 951. The tabs 1002 may be an oblong shape or oval-shaped. However, it is contemplated that any type of shape can be used to form the tabs 1002. In some non-limiting embodiments or aspects, four tabs 1002 may be provided on the dial 951. It is to be understood that, in certain circumstances, there may be out-of-axis forces that cause the load on the tabs 1002 closer to the outlet of the bowl 352 to experience greater forces, which results in a variety of shapes, sizes, and number of tabs 1002 that can be provided.

With reference to FIG. 9, according to one non-limiting embodiment or aspect of the present disclosure, the force limiting mechanism 1000 may also include corresponding slots 1004 configured to receive the tabs 1002 of the dial 951. The slots 1004 may be positioned near or adjacent to the end of the bowl 952 that includes the nozzle 960. The slots 1004 may include a first end 1006a that extends in a circumferential direction relative to the outer surface of the bowl 952, a middle portion 1006b that extends in a circumferential direction relative to the outer surface of the bowl 952 and an axial direction, and a second end 1006c that direction relative to the outer surface of the bowl 952. The first end 1006a is provided opposite to the second end 1006c. The middle portion 1006b may define at least one aperture 1008 configured to receive a corresponding tab 1002 from the dial 951. During assembly of the bowl 952, the tabs 1002 of the dial 951 are positioned in the first end 1006a of a corresponding slot 1004. As the dial 951 is rotated to attach to the bowl 952, the tabs 1002 are moved along the slots 1004 from the first end 1006a into the middle portion 1006b. As the dial 951 is rotated relative to the bowl 952, the tabs 1002 are directed along the slots 1004 and are locked into the apertures 1008.

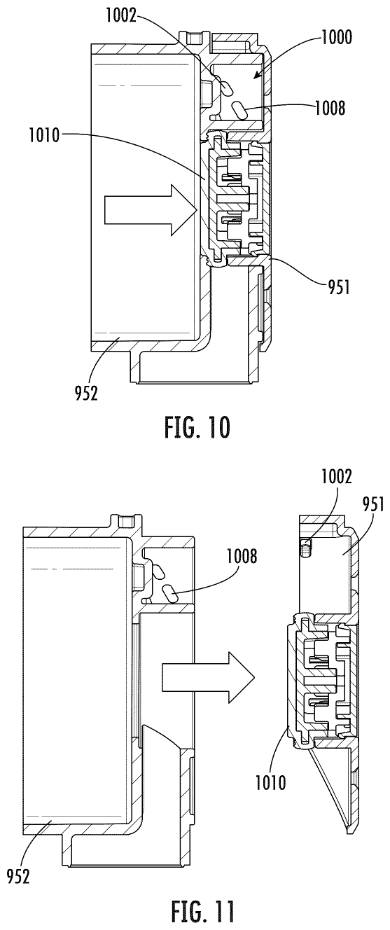

With reference to FIG. 8 again and FIGS. 10-11, according to one non-limiting embodiment or aspect of the present disclosure, the dial 951 may also include a seal 1010. The seal 1010 may be positioned at the center of the dial 951. With reference to FIG. 10, during an extrusion process hard (e.g., frozen) or larger ingredients may press against the seal 1010. In a typical use of the bowl 952, the plunger 702 would continue to extrude the processed food ingredients from the nozzle 960 of the bowl 952, which would result in damage to the plunger 702 and/or the drive train for the plunger 702 since the hard or larger ingredient may exert a force pushback on the plunger 702. This force pushback on the plunger 702 may damage to the plunger 702 and/or drive train for the plunger 702 since the plunger 702 can not exert a large enough force against the hard or larger ingredients to extrude them from the bowl 952.

As shown in FIG. 11, in order to avoid this damage to the plunger 702 and/or drive train of the plunger 702, the tabs 1002 may be configured to pop out of or release from the apertures 1008 to force the dial 951 to release from the bowl 952. In the event the hard or larger ingredients are pressed directly against the seal 1010 by the plunger 702, the force exerted by the plunger 702 will be transferred to the tabs 1002, resulting in the tabs 1002 being pushed out of the apertures 1008 to allow the dial 951 to release from the bowl 952 and to eliminate the force pushback that is being applied to the plunger 702 from the hard or larger ingredients. In the event the tabs 1002 were not provided on the dial 951 to allow release of the dial 951 from the bowl 952, the plunger 702 may continue to attempt to extrude the hard or larger ingredients, which would result in a large amount of force pushback on the plunger 702 and/or drive train of the plunger 702. In some examples, the tabs 1002 are configured to release from the apertures 1008 upon a force of 150 kilogram-force or greater being applied to the seal 1010.

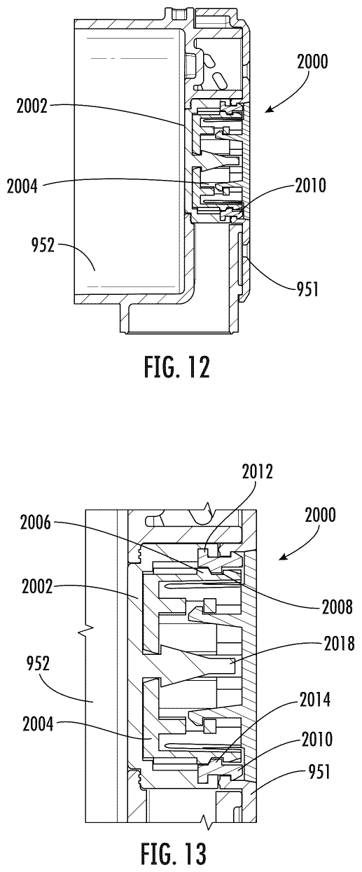

With reference to FIG. 12, according to one non-limiting embodiment or aspect of the present disclosure, a different type of force limiting mechanism 2000 is provided on the dial 951 to eliminate force pushback on the plunger 702 during an extrusion process. Similar to the force limiting mechanism 1000 discussed above, the force limiting mechanism 2000 of this embodiment or aspect is configured to release pressure against a seal 2002 held in the dial 951 when a heavy (e.g., frozen) or larger ingredient is being pressed against the seal 2002 by the plunger, thereby creating force pushback on the plunger 702.

As shown in FIG. 12, the seal 2002 may receive a base member 2004 in a cavity defined by the seal 2002. The base member 2004 includes a tab 2006 that extends from an outer surface thereof and defines an aperture 2008 in the outer surface thereof. A retaining member 2010 is also provided and received in the cavity defined by the seal 2002. The retaining member 2010 includes a first tab 2012 that extends from an outer surface thereof and a second tab 2014 that extends from an inner surface thereof. The first tab 2012 is configured to engage with an aperture defined in an inner surface of the seal 2002. The second tab 2014 is configured to engage with the aperture 2008 defined by the base member 2004.

During an extrusion process of the micro-puree machine, as the plunger 702 extrudes processed food ingredients from the bowl 952, heavier or larger ingredients may be pushed directly against the seal 2002 resulting in force pushback on the plunger 702 and/or the drive train of the plunger 702. To release pressure from the plunger 702, the seal 2002 is configured to move away from the plunger 702 or interior of the bowl 952. As the seal 2002 is pushed outwardly, the tab 2006 of the base member 2004 begins to press against and move along a surface of the second tab 2014 of the retaining member 2012. With sufficient pressure against the seal 2002, the tab 2006 is pressed against the second tab 2014 with sufficient force to move past the second tab 2014 to allow the base member 2004 to move outwardly relative to the seal 2002. By allowing the base member 2004 to move outwardly relative to the seal 2002, the force pushback is reduced and/or eliminated against the plunger 702 based on the seal 2002 being allowed to flex or push outwardly. Due to the post member 2018 of the seal 2002 being retained in the base member 2004, the seal 2002 is not fully released from the dial 951. Instead, the seal 2002 is permitted to flex or move slightly to reduce the force pushback on the plunger 702. The post member 2018 may be inserted into an aperture defined in a center of the base member 2004. In some examples, the base member 2004 is moved past the retaining member 2012 when a force of at least 150 kilogram-force is pressed against the seal 2002.

While the disclosure particularly shows and describes preferred embodiments, those skilled in the art will understand that various changes in form and details may exist without departing from the spirit and scope of the present application as defined by the appended claims. The scope of this present application intends to cover such variations. As such, the foregoing description of embodiments of the present application does not intend to limit the full scope conveyed by the appended claims.

We claim:

What is claimed is:

1. A bowl for use with a micro-puree machine, the bowl comprising:
a first end, a second end, and a sidewall extending between the first and second ends, the sidewall defining an interior volume of the bowl, the second end of the bowl including an outlet in fluid communication with an interior of the bowl; and
a dial configured to be operatively connected to the second end of the bowl, the dial comprising:
a seal; and
at least one tab extending from an inner surface of the dial,
wherein at least one slot is defined on an exterior surface of the bowl at the second end thereof, the at least one slot corresponding to the at least one tab.

2. The bowl of claim 1, wherein, upon a sufficient pressure being applied to the seal of the dial, the at least tab is configured to release from the at least one slot.

3. The bowl of claim 1, wherein the sufficient pressure is at least 150 kilograms-force.

4. The bowl of claim 1, wherein the at least one slot comprises a first end, a second end, and a middle portion extending between the first and second ends, in which the first and second ends extend circumferentially about the second end of the bowl.

5. The bowl of claim 1, wherein, upon a sufficient pressure being applied to the seal of the dial, the at least tab is configured to release from the at least one slot, in which the sufficient pressure is predetermined.

6. The bowl of claim 1, wherein the at least one tab comprises at least two tabs circumferentially positioned around the inner surface of the dial.

7. The bowl of claim 1, wherein a number of tabs provided on the inner surface of the dial corresponds to a number of slots defined on the outer surface of the second end of the bowl.

8. The bowl of claim 1, wherein the at least one tab comprises at least two tabs that correspond to the same slot.

9. The bowl of claim 1, wherein the at least one tab is oblong-shaped.

10. The bowl of claim 1, wherein, upon a sufficient pressure being applied to the seal of the dial, the at least tab is configured to release from the at least one slot to allow the dial to release from the second end of the bowl.

11. A bowl for use with a micro-puree machine, the bowl comprising:
a first end, a second end, and a sidewall extending between the first and second ends, the sidewall defining an interior volume of the bowl, the second end of the bowl including an outlet in fluid communication with an interior of the bowl; and
a dial configured to be operatively connected to the second end of the bowl, the dial comprising:
a seal;
a base member received by a cavity defined by the seal; and
a retaining member held in the seal and operatively engaged with the base member,
wherein, upon sufficient pressure being applied against the seal, the base member and retaining member are configured to release from one another.

12. The bowl of claim 11, wherein, upon release of the base member and retaining member from one another, the seal is configured to move relative to the dial to release the pressure exerted against the seal.

13. The bowl of claim 11, wherein the seal is operatively engaged with the base member.

14. The bowl of claim 13, wherein the seal comprises a post member that is received in an aperture defined by the base member.

15. The bowl of claim 11, wherein the base member comprises at least one tab configured to operatively engage with at least one tab extending from the retaining member.

16. The bowl of claim 15, wherein, upon sufficient pressure being exerted against the seal, the at least one tab of the base member is pushed past the at least one tab of the retaining member to allow the seal to move relative to the dial to release the pressure being exerted on the seal.

17. The bowl of claim 15, wherein the base member defines at least one aperture to receive the at least one tab of the retaining member.

18. The bowl of claim 11, wherein the retaining member comprises at least one tab extending from an outer surface thereof and that is received in an aperture defined in an inner surface of the seal.

19. A method of releasing pressure in a bowl for a micro-puree machine, the method comprising:
operatively connecting a dial to the bowl of the micro-puree machine; and
releasing the dial from the bowl of the micro-puree machine upon a predetermined force being applied to the dial.

20. The method of claim 19, wherein the dial is configured to fully release from the bowl upon the predetermined force being applied to the dial.
